(19) United States
(12) Patent Application Publication
(10) Pub. No.: US 2017/0315965 A1
(43) Pub. Date: Nov. 2, 2017

(54) SYSTEMS, METHODS AND ARTICLES TO AUTOMATICALLY TRANSFORM DOCUMENTS TRANSMITTED BETWEEN SENDERS AND RECIPIENTS

(71) Applicant: ECMARKET INC., Vancouver (CA)

(72) Inventors: Cristinel Dan Pirvu, Coquitlam (CA); Brent Wayne Halverson, Vancouver (CA); Ian Campbell Braby, North Vancouver (CA)

(21) Appl. No.: 15/594,220

(22) Filed: May 12, 2017

Related U.S. Application Data
(62) Division of application No. 14/346,674, filed on Mar. 21, 2014.
(60) Provisional application No. 61/538,674, filed on Sep. 23, 2011.

(51) Int. Cl. G06F 17/21; G06F 17/30; G06F 17/22

(52) U.S. Cl. CPC G06F 17/211; G06F 17/2264; G06F 17/30011

(57) ABSTRACT

A document transformation system automatically transforms documents electronically transferred between senders and recipients, even where documents of a given type from a given sender which are assumed to be identically formatted differ in various aspects, for instance in scaling, alignment, concatenating, resizing, etc. Document transformation instructions selected based on sender, recipient, or both specify transformation instructions which include one or more maps, document layouts, page layouts, sections extraction instructions, allowing extraction of data or information, and generation of documents or information in a format specified by recipient. Headers and footers may be extracted, and a remaining body concatenated. The system continues to searching for additional instructions on failure of previous instructions to successfully extract a previous section, without terminating. Documents may be converted from a large variety of file formats into a common file format. Extracted information may be stored in a database.

### BACKGROUND

### Technical Field

This disclosure generally relates to automated document transfer, and more particularly to automated document transformation, which may be used in transforming documents, for example for use in electronic data interchange.

### Description of the Related Art

Document transfer is fundamental to many applications. For example, many businesses exchange business documents, for example purchases orders (POs) and/or invoices. For many years entities such as businesses, governments, non-government organizations, and even individuals exchanged paper documents. With the increasing use of computers such paper documents have become cumbersome, typically requiring the use of valuable resources to enter the information contained in the paper document into computing systems, and often resulting in numerous errors.

Such has led to the development of various systems for electronic exchange of documents. Most notably, electronic data interchange (EDI) standards were developed by the National Institute of Standards and Technology, specifying rigorously defined, standardized formats for the electronic exchange of documents. Such standards are independent of specific communications infrastructure and/or software employed, allowing senders and recipients large latitude in selecting a desired communication infrastructure and software. For example, the EDI standards are compatible with communications via asynchronous and synchronous modems, file transfer protocol (FTP), electronic mail (email), hypertext transfer protocol (HTTP), Applicability Statement 1 or 2 (AS1, AS2) specifications.

These entities typically have their own internal systems, and may employ any number of communications technologies to transmit documents. As noted above, documents may be exchanged in various formats via various communications infrastructures, for instance, via facsimile machines, file transfers using FTP, and/or exchanged as attachments to emails. Further, entities may employ a large variety of file formats, for instance Microsoft Word files, Microsoft Excel files, Adobe PDF files, printer control language (PCL) files, comma delimited files, etc. Further, these entities may employ a large variety of document formats or document layouts for their documents. Often, the documents will include one or more pages, each with one or more sections. For instance, each page may include a header section, a footer section, and a body section between the header and footer sections. Where the document takes the form of a purchase order, the body section may be denominated as a line item section, setting out one or more line items which are the subject of the purchase order.

It is desirable that documents transmitted by one entity be automatically transformed into a form suitable for use by a system of the receiving or recipient entity. While a pair of entities may generally agree to an acceptable form of communications, document formats and even file format, there are often inconsistencies in documents as generated from these agreed upon standards. These inconsistencies would often be considered minor if visually inspected by a human, however these same inconsistencies may prevent conventional document processing systems from automatically handling the documents without human intervention. As previously noted, human intervention is costly, and prone to errors.

Hence, new approaches to document transfer, and particularly to document transformation are desirable.

### BRIEF SUMMARY

Described herein are automated document transformation systems (DTSs) and methods of performing automated document transformation which accept as input non-image electronic document files containing data in a variety of document formats or document layouts, page layouts and file formats, and, via a set of transformation instructions contained in a separate electronic file, produces as output an electronic document file containing some or all of the contents of the input document, formatted in any of a variety of structured data formats.

The DTS can also insert new content into the resulting output electronic document file. The newly inserted content may be determined based on the content of document as received from a sender or originator, or may be inserted directly into the resulting output document irrespective of the content of the received document.

Counter to conventional wisdom or common sense, specific instances of documents of a given document type (e.g., purchase order, invoice) and sent by a same given sender are often inconsistent in one or more aspects, for example having an inconsistent document layout and/or inconsistent page layout. The implication is that, even knowing the identity of the sender, the document type and the identity of the recipient, an input document cannot always be transformed automatically into an output document using conventional approaches. A simple example of inconsistent input data format occurs when data elements may or may not be present on a page. A more complicated example occurs when documents are scaled down (e.g., shrunken) when created, resulting in all data elements being in different and unexpected locations on the page. Reliable automated document transformation without manual intervention is typically not possible in cases of inconsistent input data. The DTS may be capable of automatically handling these inconsistencies, typically without requiring any manual intervention.

At least one of the approaches described herein employs a two-fold solution. First, a received document is converted to a desired or default format (e.g., DTE format), and then the converted input data or information is normalized to identify and remove anomalies (e.g., scaling, overlapping data elements). Second, a relative offset mapping is employed to allow data elements to appear in unexpected positions or locations and still be located or “found” by a Document Transformation Engine (DTE) without requiring manual intervention. Now, instead of specifying the position or location of a data element using a fixed location on a page, the position or location of the data element can be specified as an offset relative to a position or location of another data element, which can be found without using a fixed location (e.g., a column heading, section title) The concept of relative offset mapping can be applied from simple cases (e.g., relative to one fixed label) to extremely complex cases where a position or location of a given data element is defined as relative to more than one data element in order to account for the existence, or absence, of data elements on a page.

In some aspects, it may be easier to understand the DTS design paradigm as being based on a human view of a “document” as a collection of one or more “pages” with each “page” being a collection of one or more “sections” which in turn are each a collection of one or more “data elements” some or all of which may contain data or information, for example alphanumeric characters. A document layout definition may define or specify the layout of a document, for example the total number of pages. One or more page layout definitions may define or specify the layout of one or more pages, for example the sections and/or data elements, including the positions and semantic meanings of the same.

The design paradigm may use a two dimensional reference frame (e.g., XY-coordinate matrix whose axes intersect at the top-left corner of each “page” as defined as X=0, Y=0), to specify a position or location of each data element on each “page.” The position or location may be specified using four discrete pairs of XY-coordinates to delimit a rectangle inside which all or a portion of the data or information is found. Notably, the rectangle is a virtual construct and may not actually appear on a printed or displayed page. Alternatively, the position or location may be specified using one pair of XY-coordinates along with a length and a height, again to delimit an area inside which all or a portion of the data or information is found. The unit of measure for both axes may be denominated in pixels, with the increments determined by a resolution (i.e., the number of pixels per page) used in creating each document. With the data elements of the document thus represented in terms of their position or location on a page, the DTS may systematically identify and extract data or information, if any, from each data element in the input document for use in producing an output document file as specified.

Automated document transformation is accomplished by creating a set of transformation instructions for an input document that the Document Transformation Engine (DTE), in conjunction with the input document, follows to create the output document.

Document transformations may include converting a received or input document to a desired or default DTE file format (i.e., data element, location, page#), followed by normalization of the DTE-formatted file. The normalized DTE-formatted input document may be loaded into memory. The system may determine a corresponding document layout, for example whether the received or input document is single- or multi-page document. The system may determine a corresponding page layout. The system may identify, extract and/or record data or information from each data element in a first or “header” section of each page. The system may identify, extract and/or record data or information from each data element in a second or “footer” section of each page. Extracting data or information removes the extracted data or information from the non-transitory processor-readable memory, thereby removing the data or information associated with the “header” and “footer” sections from the memory or memory vector. The system may eliminate pagination by assembling all remaining data or information on one virtual page, for instance containing only a body or “line item” section of the document. The system may then identify, extract and/or record data or information from each data element in the body or “line item” section. The system may perform a set of quality assurance (QA) operations on the transformation of the received or input document to an output document. The system may optionally insert new or modify existing data or information in the output document which may be specified by requirements of the sender or originator and/or by the intended recipient or receiver. The system may generate an output file in a structured data format with all extracted/recorded/inserted/modified data or information included.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a schematic diagram of a networked environment, including a number of document transformation computer systems communicatively coupled between servers and/or computing systems of a number of sending entities and a number of recipient entities, according to one illustrated embodiment.

FIG. 2 is a schematic diagram of an electronic commerce environment having a document transformation computer system, communicatively coupled to a sending entity computer system, a recipient entity computer system and a value added network computer system, according to one illustrated embodiment.

FIG. 3 is a plan view of an exemplary document in the form of a purchase order, according to one illustrated embodiment.

FIG. 4 is a flow diagram showing a high level method of transforming a document transmitted by a transmitting entity to a recipient entity, according to one illustrated embodiment.

FIGS. 5, 6, 7A and 7B are a flow diagram showing a low level method of transforming a document including converting a document type, normalizing the converted document, obtaining instructions and extracting information from header and footer sections in accordance with the instructions, extracting information from body or line item sections, performing quality assurance and inserting or modifying the data or information in accordance with the instructions according to one illustrated embodiment, which may be implemented as part of the method illustrated in FIG. 4.

FIG. 8 is a flow diagram showing a low level method of converting a document, according to one illustrated embodiment, which may be implemented as part of the method illustrated in FIGS. 5, 6, 7A, 7B.

FIG. 9 is a flow diagram showing a low level method of normalizing a document, according to one illustrated embodiment, which may be implemented as part of the method illustrated in FIGS. 5, 6, 7A, 7B.

FIG. 10 is a flow diagram showing a low level method of extracting information from a section of a document and determining whether the extraction was successful, according to one illustrated embodiment, which may be implemented as part of the method illustrated in FIGS. 5, 6, 7A, 7B.

FIG. 11 is a flow diagram showing a low level method of performing quality assurance, according to one illustrated embodiment, which may be implemented as part of the method illustrated in FIGS. 5, 6, 7A, 7B.

FIG. 12 is a flow diagram showing a low level method of manipulating data or information, according to one illustrated embodiment, which may be implemented as part of the method illustrated in FIGS. 5, 6, 7A, 7B.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with computing systems including client and server computing systems, as well as networks and other communications channels have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

The headings and Abstract of the Disclosure provided herein are for convenience only and do not interpret the scope or meaning of the embodiments.

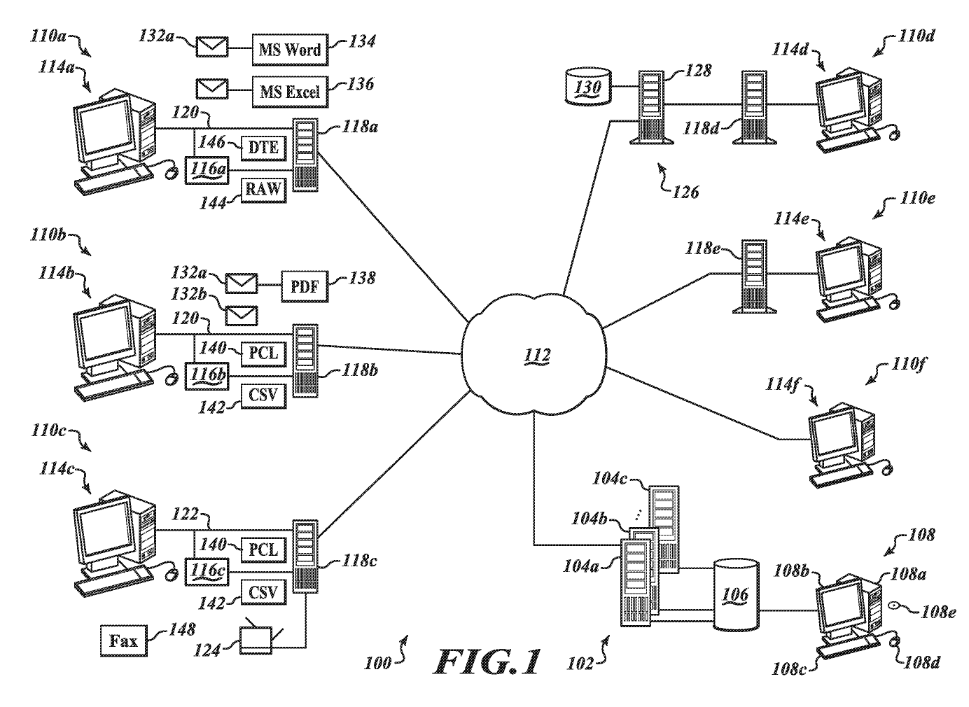

FIG. 1 shows an environment 100, according to one illustrated embodiment in which various apparatus, methods and articles described herein may operate to transform and exchange documents between various entities.

The environment 100 includes a document transformation system 102 operated by a document transformation entity or service, for example as a value added network (VAN). The document transformation system 102 may comprise a number of document transformation server computing systems 104a-104c (three illustrated, collectively 104). The document transformation server computing systems 104 include processors that execute instructions, for example server instructions (i.e., server software), stored on non-transitory computer-readable storage media to provide functions, for example document transformation server functions, in the environment 100. For instance, the document transformation server computing systems 104 may receive documents sent by senders to intended recipients, transform the received documents, and transmit the transformed documents to the intended recipients. Some of the document transformation server computing systems 104 may be dedicated to certain senders or document originators, or to pairs of document exchange entities (i.e., send/intended recipient pairs). Other ones of the document transformation server computing systems 104 may handle documents exchanged between a variety of sender and intended recipient entities, for example selecting documents out of a queue, for example based on order received (e.g., first in, first out), and may, or may not, take into account a prioritization. While described with respect to business documents, for example purchase orders and invoices, the various embodiments are not limited to such business documents, nor limited to use with business documents, but rather can be employed with any type of document.

As used herein and in the claims, a document refers to a collection of data or information, which when in human readable form is typically arranged on one or more pages. The visual layout of data or information on the pages is referred to herein as the document format. The data or information is non-graphical or non-image data, for example a collection of alphanumeric characters. A page is a collection of one or more data elements, which include discrete pieces of data or information (e.g., a sender's address, an item identifier or description, a cost, a sum or total). A document is typically handled and/or manipulated in an electronic or digital representation, referred to herein as a file. The file may be in any of a variety of file formats (e.g., Microsoft Word files, Microsoft Excel files, Adobe PDF files, printer control language (PCL) files, comma delimited files). The electronic or digital representation is commonly considered machine-readable rather than human-readable. The arrangement of data or information in the file is typically very different from the document format. However, the file can be rendered (e.g., printed, displayed) into the document format.

As described in more detail below, the instructions may include various sets of file transformation instructions. Each set of file transformation instructions may include one or more maps which each provide instructions for transforming one or more documents, for example documents exchanged between a defined sender/intended recipient pair. Each map may include one or more document layout definitions which define the document layout of respective documents. For example, a map may include a number of document layout definitions for one page documents, another number of document layout definitions for two page documents, a third number of document layout definitions for three page documents, and so on. Each document layout definition may include one or more page layout definitions which define the layout of respective pages of the corresponding document. Page layout definitions define the layout of pages, for example the number and positions of sections (e.g. header, footer, body), and the number and positions of data elements. Each page layout definition may include one or more sets of section specific extraction instructions. For example, each page layout definition may include one or more sets of header specific extraction instructions, one or more sets of footer specific extraction instructions and/or one or more sets of body specific extraction instructions, for instance line item specific extraction instructions.

The transformation instructions may also include instructions for normalizing documents. Optionally, instructions for transforming between file formats may be included.

The sets of instructions may be associated with identifying data or information that allows specific sets of instructions to be selected based at least in part on an identity of an entity that transmits the document and an identity of an intended recipient of the document. Optionally, instructions may additionally be selected based on one or more document characteristics such as file format (e.g., HTML, comma delimited, Microsoft Word) and/or document type (e.g., purchase order, invoice).

The document transformation system 102 may also include one or more databases or other structured data collection 106 stored on non-transitory computer-readable storage media (only one illustrated). The databases or other structured data collection 106 may be populated with information extracted from received documents. The databases or other structured data collection 106 may advantageously be queryable (e.g., Sequential Query Language or SQL databases). Such allows the document transformation server computing systems 104 to automatically retrieve and provide to the recipients only the information specified by the recipients.

The document transformation system 102 may also include one or more interface computer systems 108 (only one shown) including a computer 108a, a monitor 108b, and one or more user input devices (e.g., keyboard 108c, mouse 108d). The interface computer system(s) 108 are communicatively coupled to the document transformation server computing systems 104. The interface computer system(s) 108 may be employed in a variety of manners for interfacing with the document transformation server computing systems 104. For example, the computer systems may include one or more processors that execute instructions stored on one or more computer-readable storage mediums 108e. The instructions may implement a graphical user interface (GUI) 108b. The GUI may allow the creation of new sets of file transformation instructions and/or the modification of existing sets of file transformation instructions.

The environment 100 includes a number of clients 110a-110f (collectively 110) selectively communicatively coupled to one or more of the server computing systems 104 via one or more communications networks or channels 112. The client systems 116 are associated with one or more entities which exchange documents (i.e., send and/or receive). In many instances, any given entity will at one time function as a sender, sending or transmitting a document to another entity who functions as a recipient or intended recipient. At other times, the given entity functions as a recipient or intended recipient, receiving documents sent by another entity. Thus, the clients 110 may function as both senders and recipients in document exchanges.

Documents may be referred to as inbound documents, or outbound documents, indicating a respective direction of the document exchange with respect to a given recipient. Thus, a given document may be considered or denominated as an outbound document with respect to or from the perspective of a transmitting or sending entity, while the same document may be considered or denominated as an inbound document with respect to or from the perspective of the receiving or recipient entity.

The clients 110 may include various devices for exchanging documents. Typically the clients will include one or more client computing systems 114a-114f (collectively 114) which may include one or more processors that execute one or more sets of communications instructions (e.g., browser instructions) stored on any of a variety of non-transitory computer-readable storage media. The client computing systems 114 may take a variety of forms, for instance desktop or laptop personal computers, work stations, mini-computers, mainframe computers, or other computational devices with microprocessors or microcontrollers which are capable of networked communications. The client computing systems 114 may include one or more monitors or displays, user input devices (e.g., keyboards, keypads, mice, trackballs, track pads, joysticks). One of more of the client computing systems 114e may take the form of a back office system, for example a back office accounting system or supply chain management system which implement accounting and order fulfillment and/or tracking operations. It is recognized that the physical location of computer systems or other devices under control of each entity may be in various locations with, or remote from, the various physical business locations, office headquarters, retail centers, or residences associated with each entity.

Some of the client computing systems 114 may implement virtual printers 116a-116c (collectively 116) which in response to a print command transforms a document into a format suitable for electronic data exchange. Such functionality replicates some aspects of the previous function of printing purchase orders or invoices, which were traditionally mailed or sent via facsimile machine. However, instead of actually printing the document, the virtual printer 116 prepares and electronically transmits the document in electronic form.

One or more of the clients 110 may include one or more client server computing systems 118a-118e (collectively 118). The client server computing systems 118 may serve the client computing system(s) 114 via a client local area network (LAN) 120 (only one called out in FIG. 1) or client wide area network (WAN) 122 (only one called out in FIG. 1). The client server computing systems 118 may take any variety of forms of computer systems, particularly those executing server software. Typically, the client server computing system 118 will implement a firewall between the client LAN 120 or client WAN 122 and outside networks (e.g., Internet) or channels 112.

Some of the clients 110c may rely on devices such as facsimile machines 124 for exchanging documents. Facsimile machines 124 may convert paper documents into an electronic form. Alternatively, some client computer systems 114 may implement virtual facsimile functions, transforming an electronic document into the same file format as employed by facsimile machines, without requiring the sender to print a paper document.

Further, some clients 110d may rely on intermediary VAN 126 in the document exchange. The intermediary VAN 126 may perform one or more functions to facilitate the transfer or management of document exchange or business between the entities. For example, the intermediary VAN 126 may route transactions to a final recipient, retransmitting documents, providing third party auditing, etc. The intermediary VAN 126 may include one or more server computing systems 128 and databases 130 stored on non-transitory computer-readable media.

The document transformation server computing systems 104, various clients 110, and/or VAN(s) 126 may be communicatively coupled via one or more communications networks or channels 112. The communications networks or channels 112 may take a large variety of forms. For instance, the communications networks or channels 112 may include wired, wireless, optical, or a combination of wired, wireless and/or optical communications links. The one or more networks or channels 112 may include public networks, private networks, unsecured networks, secured networks or combinations thereof. The one or more communications networks or channels 112 may employ any one or more communications protocols, for example TCP/IP protocol, UDP protocols, IEEE 802.11 protocol, as well as other telecommunications or computer networking protocols. The one or more communications networks or channels 112 may include what are traditionally referred to as computing networks and/or what are traditionally referred to as telecommunication networks or combinations thereof. In at least one embodiment, the one or more communications networks 112 include the Internet, and in particular, the Worldwide Web (referred to herein as “the Web”). Consequently, in at least one embodiment, one or more of the server computing systems 104, 118, 128 execute server software to serve HTML source files or Web pages, and one or more client computing systems 114, execute browser software to request and display HTML source files or Web pages. The communications networks or channels 112 may include legacy systems, such as that commonly described as plain old telephone service (POTS). Such may be particularly suited for use with facsimile machines 124.

At a high level, the document transformation server computing systems 104 receive documents being exchanged between clients. In particular, the document transformation server computing systems 104 receives documents sent by a sender to a recipient or intended recipient. The document transformation server computing systems 104 may determine or identify an appropriate a set of document transformation instructions, and transform the document accordingly. The document transformation instructions may be determined or selected based on a variety of criteria, for example identity of sender and/or identity of recipient. The document transformation may include one or more distinct transformations. For example, the document may be transformed from one file format to another. Also for example, the document may be transformed from one document format to another document format. The document may be normalized to facilitate automated document transformation. Information may be extracted from the document. Extracted information may be stored, either temporally or permanently, in a database or other structured data store. The document transformation server computing systems 104 may generate and transmit a document to the intended recipient in a recipient specified format and file format, including recipient specified information extracted from the document sent by the sender. All may be advantageously achieved with no, or little, human intervention.

FIG. 1 illustrates a few example documents which may be exchanged between entities. For example, a sender may transmit a document attached as an attachment to an email 132a. The attachment may have any of a large variety of file formats, for instance a word processing document (e.g., Microsoft Word®) 134, a spreadsheet (e.g., Microsoft Excel®) 136 or an image file with underlying text (e.g., Adobe Portable Document Descriptor Format or PDF® document) 138. The body of an email 132b may also constitute a document, for example a hypertext markup language (e.g., HTML) document. Documents may also be sent as printer control language (PCL) documents 140, or comma delimited (e.g., CSV) documents 142. The virtual printers 116 may send documents in either raw form 144 or formatted in a document transformation file format 146 specified by the entity that performs the document transformation, for example DTE™ file format specified by ECMARKET of Vancouver, B.C., Canada. The facsimile machine 124 may transmit a facsimile document 148.

Although not required, the embodiments will be described in the general context of computer-executable instructions, such as program application engines, objects, or macros stored on computer- or processor-readable storage media and executed by a computer or processor. Those skilled in the relevant art will appreciate that the illustrated embodiments as well as other embodiments can be practiced with other affiliated system configurations and/or other computing system configurations, including hand-held devices, multiprocessor systems, microprocessor-based or programmable consumer electronics, personal computers (“PCs”), network PCs, mini computers, mainframe computers, and the like. The embodiments can be practiced in distributed computing environments where tasks or engines are performed by remote processing devices, which are linked through a communications network. In a distributed computing environment, program engines may be located in both local and remote memory storage devices.

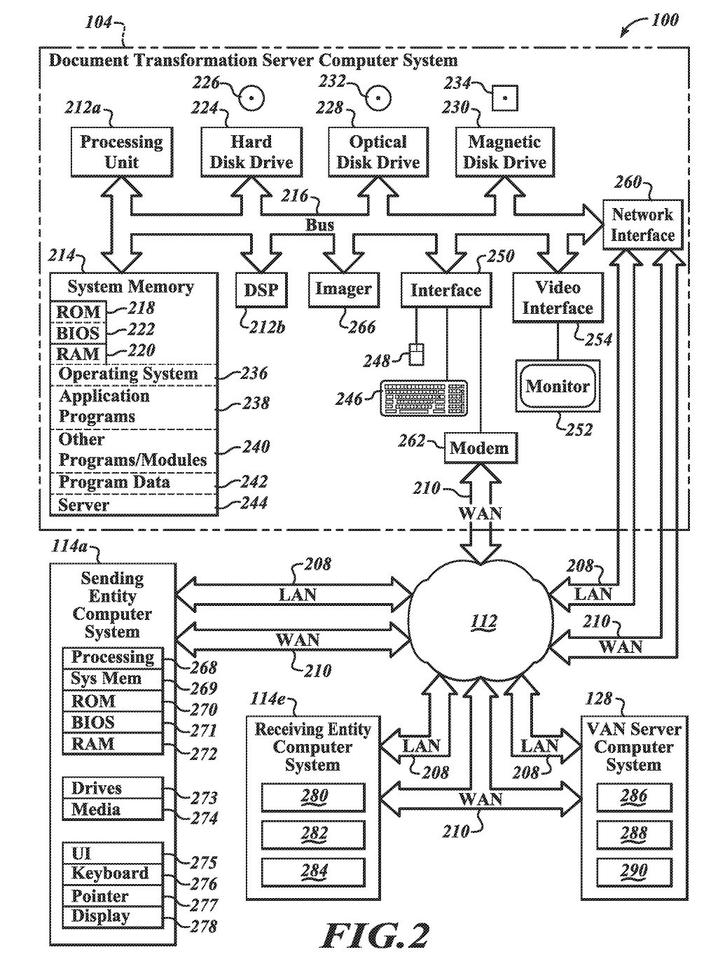

FIG. 2 shows a portion of the environment 100 comprising one document transformation server computing systems 104, a sending entity client computer systems 114a, a recipient client computing system 114e and optional VAN server computer system 128, communicatively coupled by one or more communications channels, for example one or more local area networks (LANs) 208, wide area networks (WANs) 210 and/or communications networks or channels 112.

The document transformation server computing systems 104 may include computer systems of an entity that provides document transformation services, which in at least some instances may be a separate entity from the entities which are exchanging documents. The sending and/or recipient client computing systems 114a, 114e may include computer systems of entities that are exchanging documents. The VAN server computer system 128 may be a computer systems operated by an intermediary that supplies value added services related to the document exchange.

The document transformation server computer system 104 will at times be referred to in the singular herein, but this is not intended to limit the embodiments to a single device or system since in typical embodiments, there may be more than one document transformation server computer system involved. Unless described otherwise, the construction and operation of the various blocks shown in FIG. 2 are of conventional design. As a result, such blocks need not be described in further detail herein, as they will be understood by those skilled in the relevant art.

The document transformation server computer system 104 may include one or more processing units 212a, 212b (collectively 212), a system memory 214 and a system bus 216 that couples various system components including the system memory 214 to the processing units 212. The processing units 212 may be any logic processing unit, such as one or more central processing units (CPUs) 212a, digital signal processors (DSPs) 212b, application-specific integrated circuits (ASICs), field programmable gate arrays (FPGAs), etc. The system bus 216 can employ any known bus structures or architectures, including a memory bus with memory controller, a peripheral bus, and a local bus. The system memory 214 includes read-only memory (“ROM”) 218 and random access memory (“RAM”) 220. A basic input/output system (“BIOS”) 222, which can form part of the ROM 218, contains basic routines that help transfer information between elements within the document transformation server computer system 104, such as during start-up.

The document transformation server computer system 104 may include a hard disk drive 224 for reading from and writing to a hard disk 226, an optical disk drive 228 for reading from and writing to removable optical disks 232, and/or a magnetic disk drive 230 for reading from and writing to magnetic disks 234. The optical disk 232 can be a CD/DVD-ROM, while the magnetic disk 234 can be a magnetic floppy disk or diskette. The hard disk drive 224, optical disk drive 228 and magnetic disk drive 230 may communicate with the processing unit 212 via the system bus 216. The hard disk drive 224, optical disk drive 228 and magnetic disk drive 230 may include interfaces or controllers (not shown) coupled between such drives and the system bus 216, as is known by those skilled in the relevant art. The drives 224, 228 and 230, and their associated computer-readable storage media 226, 232, 234, may provide nonvolatile and non-transitory storage of computer readable instructions, data structures, program engines and other data for the document transformation server computer system 104. Although the depicted document transformation server computer system 104 is illustrated employing a hard disk 224, optical disk 228 and magnetic disk 230, those skilled in the relevant art will appreciate that other types of computer-readable storage media that can store data accessible by a computer may be employed, such as magnetic cassettes, flash memory, digital video disks (“DVD”), Bernoulli cartridges, RAMs, ROMs, smart cards, etc.

Program engines can be stored in the system memory 214, such as an operating system 236, one or more application programs 238, other programs or engines 240 and program data 242. Application programs 238 may include instructions that cause the processor(s) 212 to automatically identify, locate and/or retrieve sets of document or file transformation instructions, transform the files or documents based on the instructions, and forward transformed documents or other information to a recipient or intended recipient of the document exchange via one or more document transformation computer systems 104, client computer systems 114 or other devices such as facsimile machine 124 (FIG. 1), and optionally VAN server computer system 128. Other program engines 240 may include instructions for handling security such as password or other access protection and communications encryption. The system memory 214 may also include communications programs for example a server 244 for permitting the document transformation server computer system 104 to provide services and exchange data with other computer systems or devices via the Internet, corporate intranets, extranets, or other networks as described below, as well as other server applications on server computing systems such as those discussed further herein. The server 244 in the depicted embodiment may be markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers are commercially available such as those from Microsoft, Oracle, IBM and Apple.

While shown in FIG. 2 as being stored in the system memory 214, the operating system 236, application programs 238, other programs/engines 240, program data 242 and server 244 can be stored on the hard disk 226 of the hard disk drive 224, the optical disk 232 of the optical disk drive 228 and/or the magnetic disk 234 of the magnetic disk drive 230.

An operator can enter commands and information into the document transformation server computer system 104 through input devices such as a touch screen or keyboard 246 and/or a pointing device such as a mouse 248, and/or via a graphical user interface. Other input devices can include a microphone, joystick, game pad, tablet, scanner, etc. These and other input devices are connected to one or more of the processing units 212 through an interface 250 such as a serial port interface that couples to the system bus 216, although other interfaces such as a parallel port, a game port or a wireless interface or a universal serial bus (“USB”) can be used. A monitor 252 or other display device is coupled to the system bus 216 via a video interface 254, such as a video adapter. The document transformation server computer system 104 can include other output devices, such as speakers, printers, etc.

The document transformation server computer system 104 can operate in a networked environment using logical connections to one or more remote computers and/or devices as described above with reference to FIG. 1. For example, the document transformation server computer system 104 can operate in a networked environment using logical connections to one or more sending client computer systems 114a, recipient client computer systems 114e and/or VAN server computer systems 128. Communications may be via a wired and/or wireless network architecture, for instance wired and wireless enterprise-wide computer networks, intranets, extranets, and the Internet. Other embodiments may include other types of communication networks including telecommunications networks, cellular networks, paging networks, and other mobile networks.

The sending client computer system 114a may take the form of a conventional mainframe computer, mini-computer, workstation computer, personal computer (desktop or laptop), or handheld computer. The sending client computer system 114a may include a processing unit 268, a system memory 269 and a system bus (not shown) that couples various system components including the system memory 269 to the processing unit 268. The sending client computer system 114a will at times be referred to in the singular herein, but this is not intended to limit the embodiments to a single sending client computer system 114a since in typical embodiments, there may be more than one sending client computer system 114a or other device involved. Non-limiting examples of commercially available computer systems include, but are not limited to, an 80x86, Pentium, or i7 series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation.

The processing unit 268 may be any logic processing unit, such as one or more central processing units (CPUs), digital signal processors (DSPs), application-specific integrated circuits (ASICs), field programmable gate arrays (FPGAs), etc. Unless described otherwise, the construction and operation of the various blocks of the sending client computer system 114a shown in FIG. 2 are of conventional design. As a result, such blocks need not be described in further detail herein, as they will be understood by those skilled in the relevant art.

The system bus can employ any known bus structures or architectures, including a memory bus with memory controller, a peripheral bus, and a local bus. The system memory 269 includes read-only memory (“ROM”) 270 and random access memory (“RAM”) 272. A basic input/output system (“BIOS”) 271, which can form part of the ROM 270, contains basic routines that help transfer information between elements within the sending client computer system 114a, such as during start-up.

The sending client computer system 114a may also include one or more media drives 273 (e.g., a hard disk drive, magnetic disk drive, and/or optical disk drive) for reading from and writing to computer-readable storage media 274 (e.g., hard disk, optical disks, and/or magnetic disks). The computer-readable storage media 274 may, for example, take the form of removable media. For example, hard disks may take the form of a Winchester drives, optical disks can take the form of CD-ROMs, while magnetic disks can take the form of magnetic floppy disks or diskettes. The media drive(s) 273 communicate with the processing unit 268 via one or more system buses. The media drives 273 may include interfaces or controllers (not shown) coupled between such drives and the system bus, as is known by those skilled in the relevant art. The media drives 273, and their associated computer-readable storage media 274, provide nonvolatile storage of computer readable instructions, data structures, program engines and other data for the sending client computer system 114a. Although described as employing computer-readable storage media 274 such as hard disks, optical disks and magnetic disks, those skilled in the relevant art will appreciate that sending client computer system 114a may employ other types of computer-readable storage media that can store data accessible by a computer, such as magnetic cassettes, flash memory cards, digital video disks (“DVD”), Bernoulli cartridges, RAMs, ROMs, smart cards, etc. Data or information, for example, data from human resource management programs or tools, third party tracking programs or tools, etc., can be stored in the computer-readable storage media 274.

Program engines, such as an operating system, one or more application programs, other programs or engines and program data, can be stored in the system memory 269. Program engines may include instructions for generating documents, for example word processing programs, spreadsheet programs, print drivers, email programs, PDF software to create PDF files, virtual facsimile program to create virtual facsimile documents, and/or commercial or proprietary programs for generating purchase orders, invoices, shipping documents, tracking documents, customs documents, or for implementing supply chain management program engines may include instructions for handling security such as password or other access protection and communications encryption. The system memory 269 may also include communications programs for example a Web client or browser that permits the sending client computer system 114a to access and exchange data with sources such as Web sites of the Internet, corporate intranets, extranets, or other networks as described below, as well as other server applications on server computing systems such as those discussed further below. The browser may, for example be markup language based, such as Hypertext Markup Language (HTML), Extensible Markup Language (XML) or Wireless Markup Language (WML), and may operate with markup languages that use syntactically delimited characters added to the data of a document to represent the structure of the document.

While described as being stored in the system memory 269, the operating system, application programs, other programs/engines, program data and/or browser can be stored on the computer-readable storage media 274 of the media drive(s) 273. An operator can enter commands and information into the sending client computer system 114a via a user interface 275 through input devices such as a touch screen or keyboard 276 and/or a pointing device 277 such as a mouse. Other input devices can include a microphone, joystick, game pad, tablet, scanner, etc. These and other input devices are connected to the processing unit 269 through an interface such as a serial port interface that couples to the system bus, although other interfaces such as a parallel port, a game port or a wireless interface or a universal serial bus (“USB”) can be used. A display or monitor 278 may be coupled to the system bus via a video interface, such as a video adapter. The sending client computer system 114a can include other output devices, such as speakers, printers, etc.

The sending client computer system 114a includes instructions stored in non-transitory computer-readable storage media that cause the processor(s) of the sending or originating client computer system 114a to provide documents intended for one or more identified intended recipients to the document transformation server computer system 104, along with supporting information such as sender identifier, digital certificate or other authentication mechanism, recipient identifier, and/or document type. The instructions also allow the sending client computer system 114a to receive information regarding document transformation and information regarding delivery of the transformed document to the identified recipient(s).

The recipient client computer system 114e may have identical or similar components to the previously described computer systems. As previously noted, any given computer system, or other device, may function as both a sending or originating device and as a recipient or receiving device. Thus, for example, a first client computer may transmit a purchase order to a second client computer that receives the purchase order. The second client computer may then send an invoice to the first client computer, which receives the invoice.

The recipient client computer system 114e may include a processing subsystem 280 including one or more non-transitory processor and computer-readable memories, a media subsystem 282 including one or more drives and computer-readable storage media, and one or more user interface subsystems 284 including one or more keyboards, keypads, displays, pointing devices, graphical interfaces and/or printers.

The recipient client computer system 114e includes instructions stored in non-transitory computer-readable storage media that cause the processor(s) of the recipient client computer system 114e to receive transformed documents, and optionally confirm receipt of the same. As previously explained, the recipient client computer system 114e may at some time send documents or originate the document exchange with another computer system. Thus, the recipient client computer 114e may include many of the same instructions as the sender client computer 114a.

The VAN server computer system 128 may take a variety of forms, for example one or more personal computers, server computers, mainframe computers, mini-computers, microcomputers or workstations. The VAN server computer system 128 may have identical or similar components to the previously described computer systems, for example a processing subsystem 286 including one or more non-transitory processor and computer-readable memories, a media subsystem 288 including one or more drives and computer-readable storage media, and one or more user interface subsystems 290 including one or more keyboards, keypads, displays, pointing devices, graphical interfaces and/or printers.

The VAN server computer system 128 may include instructions that cause the processor(s) of the VAN server computer system 128 to provide various functions associated with electronic document exchange, for example auditing functions. For the purposes of this application, the VAN server computer system 128 essentially acts as an intermediary conduit between the document transformation server computer systems 104 and the client computer systems 114, so is not discussed in detail.

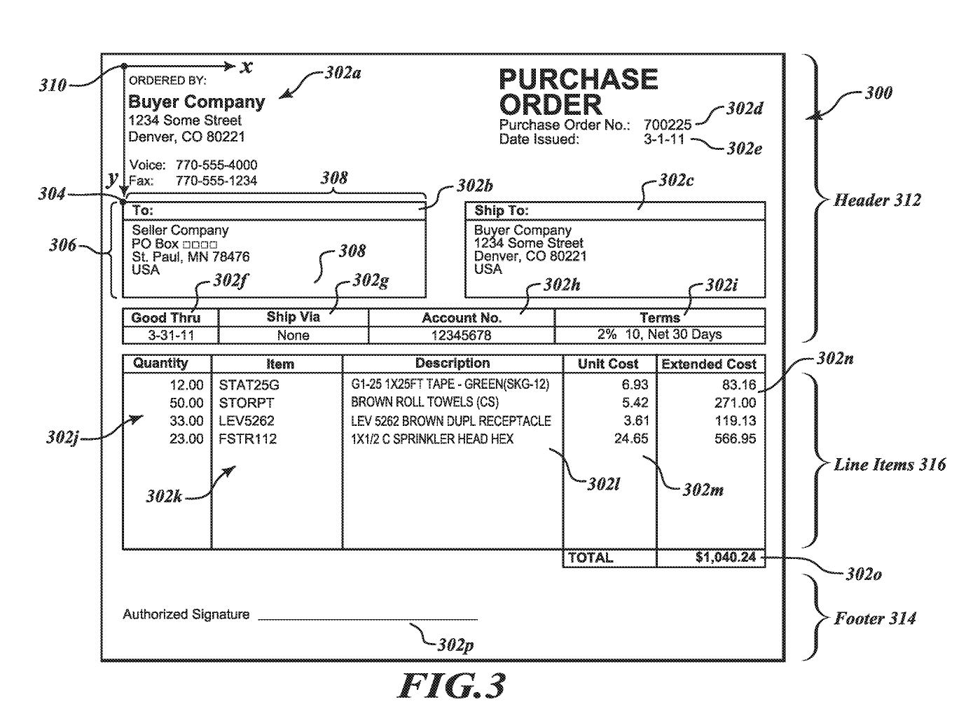

FIG. 3 shows an exemplary document in the form of a purchase order 300, according to one illustrated embodiment. Documents may take a wide variety of forms, and the illustrated example is provide to aid in discussion of the operation of the document transformation system for use in document exchange between two entities. For example, while illustrated as a single page document, in some instances the purchase order 300, or some other document, may include two or even more pages. Thus, the illustrated example should not be taken in any sense as limiting.

The purchase order 300 includes a number of data elements 302a-302p (collectively 302), which may be interchangeably referred to as areas or fields, which are arranged spatially with respect to one another according to a layout of the document (e.g., purchase order) 300. The data elements 302 are essentially two dimensional areas on the page, in which certain data or information is expected to be found if that information is present in the document (e.g., purchase order). Each data element 302 may be defined by an anchor point 304 (only one called out in FIG. 3) and a width 306 (only one called out in FIG. 3) and length 308 (only one called out in FIG. 3). Alternatively, each data element 302 may be defined by three or four points. The anchor point 304 or other points may be specified in coordinate pairs relative to some coordinate axis. For example, a perpendicular pair of axes X and Y may be defined with an origin 310 at a point, for instance at an upper left corner of the page or document, the X axis extending to the right and the Y axis extending downward. Any convenient units of measurement may be adopted, for instance sixteenths of an inch, millimeters or pixels.

Importantly, while the layout may specify the expected position or location and boundary of the various data elements 302, in use there will often be minor discrepancies. For example, one, more or all data elements 302 may have shrunk, expanded, shifted, become overlapped or wrapped onto more than one line. While seemingly minor when analyzed by a human, these discrepancies have been difficult, if not impossible, to handle in an automated fashion without human intervention. Some of the techniques described herein address these discrepancies allowing automated document transformation without human intervention, where prior attempts failed.

Specific data elements 302 for different types of documents will of course vary widely. Even the specific data elements 302 for a given type of document (e.g., purchase order) may vary between different customers or between different vendors or suppliers, or may even differ for the same entity or send/intended recipient pair. Thus, while discussed below in the way of explanation, the illustrated example should not be considered limiting.

The illustrated purchase order 300 may, for example, include an “ORDERED BY” data element 302a which may include data or information that specifies an identity and/or address of an entity placing the purchase order (e.g., buyer or customer). A “To” data element 302b may include data or information that specifies an identity and/or address of an entity (e.g., vendor or supplier) to which the purchase order 300 is sent or addressed for fulfillment. A “Ship To” data element 302c may include data or information that specifies an identity and/or address to which the goods or items which are the subject of the purchase order 300 should be delivered.

One or more data elements 302 may uniquely identify the purchase order 300. For example, a “Purchase Order No.” data element 302d may include data or information such as a unique identifier, for instance a serial number. The identifier may be unique in at least one of the entity's tracking schema. Also for example a “Date Issued” data element 302e may include data or information that specifies a date on which the purchase order 300 was issued.

One or more data elements 302 may include information that specifies details related to the purchase order 300. For example, a “Good Thru” data element 302f may include data or information that specifies a date through which the purchase order 300 is good or valid. A “Ship Via” data element 302g may contain data or information that specifies a shipping mode or carrier. An “Account No.” data element 302h may include data or information that specifies an account associated with the customer or purchaser who is placing the purchase order. A “Terms” data element 302i may include data or information specifying the terms of purchase (e.g., 2% 10, Net 30 days) for the purchase order 300.

The purchase order 300 may include a number of data elements 302 for specifying details of particular items (i.e., line items) which are the subject of the purchase order 300. For example, a “Quantity” data element 302j includes data or information specifying a quantity of a particular item being ordered. An “Item” data element 302k includes data or information that specifies or identifies the particular good being ordered. The item identifier may take a variety of forms, for example, a serial number or number of the item in a catalog. A “Description” data element 302l may include data or information that describes the item being ordered in more detail than the item identifier. A “Unit Cost” data element 302m may include data or information indicating the cost per unit of the specific item. An “Extended Cost” data element 302n may include data or information specifying the total cost for the number of a particular item ordered. The total cost may be the product of the unit cost 302m and the number or quantity 302j of the item being ordered. The purchase order 300 may also include a “Total” data element 302o which may include data or information which specifies a total amount of the purchase order 300. The total amount may be the sum of the various items amounts for the various items ordered. The purchase order 300 may also include an “Authorized Signature” data element 302p, which allows application of an authorizing signature making the purchase order 300 a binding agreement.

The pages of the purchase order 300 may be divided into one or more sections. For example, each page of a purchase order 300 may include a header section 312, footer section 314 and body or line item section 316. Some documents, including different styles of purchase orders, may include fewer sections, while other may include a greater number of sections. While generally illustrated as contiguous areas, sections may include any grouping of selected data elements, even those that would define a noncontiguous area.

In the illustrated embodiment, the header section 312 may include the various data elements 302a-302i which include the general purchase order identification or specifying data or information. The footer section 314 may, for example, include the “Authorized Signature” data element 302p as well as the “TOTAL” data element 302o. The body or line item section may include the data elements 302j-302o which specify the various items or goods (i.e., line items) being ordered, including all the related item specifying data or information and associated amounts.

The illustrated purchase order 300 may, for example be a displayed or printed visual representation implemented as a PDF file format, which may, for example, have been transmitted by a sending entity as a PDF document attachment to an email. The PDF file format represents the displayed or printed visual representation (i.e., document format) of the purchase order 300 using various underlying instructions and/or data. An example of an email and attached PDF document for the purchase order 300 is represented immediately below. In the interest of brevity, only a portion of the instructions and data for the PDF document are represented.

```
Return-Path: <receiver@receiver.com>
Received: from murder ([unix socket])
by receiver.com (Cyrus v2.2.10-Invoca-RPM-2.2.10-3.fc2) with LMTPA;
Thu, 12 May 2011 10:02:21 -0700
X-Sieve: CMU Sieve 2.2
X-Envelope-From: bill.buyer@sender.com Thu May 12 10:02:21 2011
X-Original-To: receiver.com
Delivered-To: receiver.com
Received: from sender.com (sender.com [123.456.789.123)
by receiver.com (Postfix) with ESMTP id D8E761A8A5D
for <receiver.com>; Thu, 12 May 2011 10:02:21 -0700 (PDT)
From: <bill.buyer@sender.com>
To: “” <receiver@receiver.com>
Subject: Download.pdf
Date: Thu, 12 May 2011 10:03:19 -0700
MIME-Version: 1.0
X-Security: MIME headers sanitized on receiver.com
See http://www.impsec.org/email-tools/procmail-security.html
for details. $Revision: 1.126 $Date: 2001-01-11 21:51:32-08
Content-Type: multipart/mixed;
boundary=“----=_NextPart_000_0133_01CC108B.D1E3D650”
X-Mailer: Microsoft Office Outlook, Build 11.0.5510
Thread-Index: AcwQxjFXN8XTQII+QqmlHf2P+SLT+w==
X-MimeOLE: Produced By Microsoft MimeOLE V6.00.2800.1914
Message-Id: <20110512170221.4800D1A8A5D@receiver.com>
X-Clamav-Status: Virus Free
This is a multi-part message in MIME format.
------=_NextPart_000_0133_01CC108B.D1E3D650
Content-Type: application/pdf; name=“Download.pdf”
Content-Transfer-Encoding: base64
Content-Disposition: attachment; filename=“Download.pdf”
JVBERi0xLjMNJf////8NMSAwIG9iag08PA0vVGl0bGUgKP7/AEMAXwBfAFcASQBOAEQATwBXA
                              FMA
XwBUAEUATQBQAF8AQQBUAEYAOQA5AGUAZAAuAFAARABGKQ0vUHJvZHVjZXIgKEFteXVuaSBQR
                              EYg
Q29udmVydGVyIHZlcnNpb24gMy4wMykNL0NyZWF0aW9uRGF0ZSAoRDoyMDExMDQxMjExMjkwM
                              S0w
NycwMCcpDT4+DWVuZG9iag03IDAgb2JqDTw8IC9MZW5ndGggOCAwIFIgL0ZpbHRlciAvRmxhd
                              GVE
ZWNvZGUgPj4Nc3RyZWFtCnhe5Vrbchs3Ev0C/gMeNlXMljkBMMBc9k03y9loJZmkbKcqLyqai
                              ZQy
RYeWNsl+ffoGDDAzpLXefUmltmrjIXoaje7TjdM9+mVilIb/GWWqooF/rDaTh0nZ2qJyytiqs
                              PCf
2qmZ8UXj1G490UXtnfpp8uPf4Z+w+qvIg5zR9Fbt6K2q0A2+cDdZoIiuitoqX5mirJT1bWFV1
                              RRN
T6StVOUsSlrf4NPMuIL2hf2ilso2hQ9aQKAiCdbSon5vTVHDf3xd2KZvCpgJj4klzvVNAZHSd
                              pbg
NrkhrCOxA3RkhvyC1roGPVHXZeHBzqosWtBT0il3a/VWPYALPfgS//8cXjheTr552Spwe9V4p
                              ZY/
wkoLwhyhoM6Rf5cb8n8FYis1vb75Wi1/njhTaKdAevlewaqueXV+8oqWwQI4cly28vLR4oyWz
                              5aT
1xMN9oglRivwZj20xMDRS4seIyu0F0XL7T9IEbxq9rxaeoNAqnWNPuHXjZh5/bRb3d2ShpKwx
                              ZbO
dGHahkR04eBltfxVTT+t1dXuPQlDFCAYUdga3BaFvTYsvN6pyy3Llp2HQNaVqG6FzyBWsPnZU
                              S37
vEarwVw0pirZ3qv5KevU6IpOZ8XGTs/mtAwq2uD1bJnfTpctKO/i49F6EDz+PghGn2haGDG3o
                              fww
hHvyrkHXgDDs7J1ldyzWHz6AS062m4+3D7/vUwK55kjJDGOEr5KWoOT6Sh1vf1McLod50IXLs
                              4fY
q2XJ5oOXhiJTW+/Z37ce0kBwHlyxeCTpBjMt+olyBRYLdc07GcRWWPaVoPP2qW8Hgiyeq6pRD
                              uz9
8EL961LxwWzdZczgYHXTV5gezNXVvpM1TnIH5G1A081iAAe08hH9fiAdS10i
```

As explained herein, it may be advantageous to translate a document of a first file format to a second file format as part of the transformation process. For example, since documents may be received in a plurality of different file formats (e.g., facsimile, word processing, spreadsheet, PDF, HTML), it may be advantageous to translate those documents to some default or base file format before performing normalization and/or transformation. The illustrated embodiments employ DTE™ file format, specified by ECMARKET of Vancouver, B.C., Canada. An example of the above described purchase order 300 represented in DTE™ file format is represented immediately below. In the interest of brevity, only a portion of the data for the PDF document is represented.

```
ERPStartPageDriver
Resolution: 600, 600
Page size: 6120, 7920
ORDERED BY: | 290 | 374 | 925 | 461 | Courier New | Regular
PURCHASE | 3650 | 258 | 5285 | 536 | Courier New | Regular
BUYER COMPANY | 290 | 544 | 1719 | 671 | Courier New | Regular
1234 Some Street | 290 | 676 | 1258 | 763 | Courier New | Regular
Denver, CO 80221 | 290 | 784 | 1339 | 871 | Courier New | Regular
ORDER | 3650 | 510 | 4683 | 788 | Courier New | Regular
Purchase Order No.: 700225 | 3686 | 777 | 4925 | 864 | Courier New |
                    Regular
Date Issued: | 3686 | 892 | 4214 | 979 | Courier New | Regular
Mar. 1, 2011 | 4608 | 892 | 4882 | 979 | Courier New | Regular
Voice: 770-724-4000 | 290 | 1154 | 1218 | 1241 | Courier New | Regular
Fax: | 290 | 1262 | 467 | 1349 | Courier New | Regular
770-555-1234 | 628 | 1262 | 1218 | 1349 | Courier New | Regular
To: | 348 | 1523 | 494 | 1610 | Courier New | Regular
Ship To: | 3304 | 1523 | 3680 | 1610 | Courier New | Regular
Seller Company | 355 | 1679 | 1027 | 1766 | Courier New | Regular
Buyer Company | 3304 | 1679 | 4271 | 1766 | Courier New | Regular
PO Box 3327 | 355 | 1787 | 909 | 1874 | Courier New | Regular
1234 Some Street | 3304 | 1787 | 4272 | 1874 | Courier New | Regular
St. Paul, MN 78476 | 355 | 1895 | 1196 | 1982 | Courier New | Regular
Denver, CO 80221 | 3304 | 1895 | 4353 | 1982 | Courier New | Regular
USA | 355 | 2003 | 546 | 2090 | Courier New | Regular
USA | 3304 | 2003 | 3496 | 2090 | Courier New | Regular
Good Thru | 434 | 2440 | 907 | 2527 | Courier New | Regular
Ship Via | 1543 | 2440 | 1910 | 2527 | Courier New | Regular
Account No. | 2911 | 2440 | 3459 | 2527 | Courier New | Regular
Terms | 4766 | 2440 | 5048 | 2527 | Courier New | Regular
Mar. 31, 2011 | 506 | 2596 | 831 | 2683 | Courier New | Regular
None | 1615 | 2596 | 1839 | 2683 | Courier New | Regular
12345678 | 2976 | 2596 | 3391 | 2683 | Courier New | Regular
2% 10, Net 30 Days | 4492 | 2596 | 5328 | 2683 | Courier New | Regular
Quantity | 448 | 2822 | 830 | 2909 | Courier New | Regular
Item | 1500 | 2822 | 1690 | 2909 | Courier New | Regular
Description | 2875 | 2822 | 3390 | 2909 | Courier New | Regular
Unit Cost | 4284 | 2822 | 4702 | 2909 | Courier New | Regular
Extended Cost | 5184 | 2822 | 5538 | 2909 | Courier New | Regular
12.00 | 751 | 2949 | 989 | 3036 | Courier New | Regular
STAT25G | 1053 | 2949 | 1464 | 3036 | Courier New | Regular
G1-25 1 X 25 FT TAPE - GREEN (SKG-125) | 2205 | 2949 | 3976 | 3036 |
                    Courier New | Regular
6.93 | 4672 | 2949 | 4854 | 3036 | Courier New | Regular
83.16 | 5558 | 2949 | 5796 | 3036 | Courier New | Regular
TOTAL | 4132 | 6715 | 4433 | 6801 | Courier New | Regular
$1,040.24 | 5371 | 6715 | 5789 | 6801 | Courier New | Regular
Authorized Signature | 297 | 7046 | 1174 | 7133 | Courier New | Regular
```

The header section extraction instructions for purchase order 300 may be represented in HTML file format, which is represented immediately below. In the interest of brevity, only a portion of the instructions are represented.

```
<headers>
  <name>Header 1</name>
  <section>
    <fields>
      <field>
<id>6c9199b5-08f1-46ce-a7e3-21c18605d469</id>
<text>Purchase Order No.: 70002</text>
<fontName>Courier New</fontName>
<fontStyle>Courier New</fontStyle>
<fontSize>10</fontSize>
<mandatory>true</mandatory>
<location>
          <X>3686</X>
          <Y>777</Y>
        </location>
        <size>
          <Width>1160</Width>
          <Height>87</Height>
        </size>
        <split>
          <text>Purchase Order No.</text>
          <name>Split 1</name>
          <separators>
            <separator>:</separator>
          </separators>
          <fields>
            <item>1</item>
          </fields>
          <text>Purchase Order No.</text>
          <group>PURCHASE ORDER</group>
          <name>PO NUMBER</name>
          <mandatory>true</mandatory>
        </split>
      </field>
    </fields>
  </section>
</headers>
<lineitems>
  <name>LineItem 1</name>
  <section>
    <fields>
      <field>
<id>fb0c41f3-e411-42bd-b393-df5dd0451e49</id>
<text>12.00 G1</text>
<fontName>Courier New</fontName>
<fontStyle>Courier New</fontStyle>
<fontSize>10</fontSize>
<mandatory>true</mandatory>
<location>
          <X>751</X>
          <Y>2949</Y>
        </location>
        <size>
          <Width>691</Width>
          <Height>87</Height>
        </size>
        <split>
          <text>12.00</text>
          <name>Split 1</name>
          <separators>
            <separator>.</separator>
          </separators>
          <fields>
            <item>1</item>
          </fields>
          <group>ITEM1</group>
          <name>ORDER QUANTITY</name>
          <mandatory>true</mandatory>
        </split>
      </field>
    </fields>
  </section>
</lineitems>
```

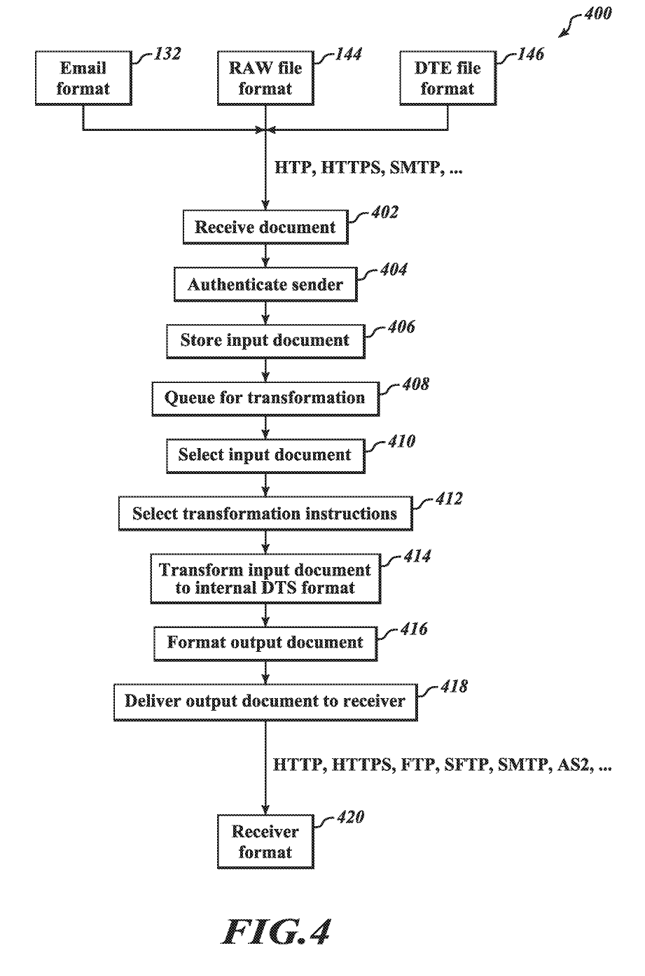

An example of operation of the transformation system is described and shown further below with reference to FIG. 4 through FIG. 12.

FIG. 4 shows a method 400 of operating a document transformation system to automatically transform documents being exchanged between two entities, according to the illustrated embodiment.

At 402, the document transformation system, for instance a document transformation server computer system, receives one or more documents 132, 144, 146 from a system or device of a sending or originating entity which documents 132, 144, 146 are intended for an intended recipient or receiving entity. As illustrated in FIG. 4, and discussed elsewhere, the received document(s) 132, 144, 146 may be received via a variety of communications infrastructures and may take any of a large variety of forms. The documents may be received via FTP or other network transfer protocol (e.g., HTTP, HTTPS, SMTP). The documents may be received in email file format 132, raw file format 144, in word processor file format (e.g., Microsoft Word®, Google Docs®, Apple Pages®), in spreadsheet file format (e.g., Microsoft Excel®, Google Spreadsheets®, Apple Numbers®), as comma delimited file format (e.g., CSV), printer control language (PCL) file format, in DTE™ file format 146 or other file formats. For example, a virtual printer executing on a client entity computing system 110 may generate a DTE™ formatted document 146 or may convert a document from one format to DTE™ formatted document 146 or generate a raw file format 144 document.

At 404, the document transformation system, for instance a document transformation server computer system, authenticates a sender of the document. The document transformation server computer system may employ a large variety of approaches to authenticating the sender. For example, the document transformation server computer system may confirm a logical address from which the document was sent is an “authorized address,” that is an address associated with a licensed entity. For instance, the document may be received with a data/time stamp, license key and other identifying information such as an email address of the sender. The document transformation server computer system may compare the sender's email address to a record of email addresses associated with the license key, to confirm that an email address of the originating system is authorized for the particular licensee.

At 406, the document transformation system, for instance a document transformation server computer system, stores the received document for processing. For example, the document transformation server computer system may store the documents to one or more non-transitory computer-readable media located either locally to the document transformation server computer system or remotely therefrom.

At 408, the document transformation system, for instance a document transformation server computer system, queues the stored received document for transformation. For example, the document transformation server computer system may maintain a pointer table, linked list or other data structure which identifies an order in which the received documents will be processed or transformed. The order or queue may be a first in, first out (i.e., FIFO) queue, for example based on the date/time stamps on the documents. The order or queue may reflect a prioritization based on one or more characteristics other than date and time of receipt. For example, certain senders, intended recipients or pairs of senders and intended recipients may take preference over other senders, recipients or pairs of senders and recipients. For instance, the system may provide preference to client entities with large accounts, or who pay a premium for faster document exchange services. Also for instance, different documents may be categorized by urgency, and with the order or queue based at least in part on the identification of a level of urgency associated with a given document. The order or queue may take into account one, more or all of the above factors, as well as other factors not enumerated herein.

At 410, the document transformation system, for instance a document transformation server computer system, selects a queued document for transformation. For example, the document transformation system may select or retrieve a document from storage according to an order or queue which order or queue reflects one or more factors that indicate a preference or preferential order amongst received documents awaiting transformation.

At 412, the document transformation system, for instance a document transformation server computer system, selects transformation instructions for transforming the queued document. For example, the document transformation system may select or retrieve transformation instructions based on an identity of a sender of the queued document, an identity of an intended recipient of the queued document or the pair of sender/intended recipients' identities.

At 414, the document transformation system, for instance a document transformation server computer system, performs document transformation on the selected received document. As explained in more detail herein, the document transformation may transform a document received from one entity, referred to as the sender or originator, into a form suitable for another entity, referred to as the intended recipient or receiver. The transformation may include transforming file format and document format, among other characteristics of the document. Also as discussed herein, numerous techniques for handling “minor” inconsistencies between documents allow an extraordinarily high percentage of documents to be transformed without any human intervention. Such is particularly advantageous in reducing the cost of electronic document exchange.

At 416, the document transformation system, for instance a document transformation server computer system, formats the output document for the recipient entity. For example, the recipient entity may have identified a desired file format, document format and even specific information to be extracted from the received document, for inclusion in the document delivered to the recipient. Such may advantageously allow the recipient to receive documents in a form consistent with the receiving entity's requirements and systems. Such may also advantageously allow the recipient to receive documents in a uniform manner (e.g., file format, document format, types of information) from a wide variety of senders even where those senders employ different file formats, document formats and/or include different types of information from one another.

At 418, the document transformation system, for instance a document transformation server computer system, transmits or forwards the resulting document 420 to at least one system or device of the intended recipient entity. As indicated in FIG. 4, the document transformation system may employ any of a large variety of transport mediums, structures or devices and/or protocols, including but not limited to HTTP, HTTPS, FTP, SFTP, SMTP, and AS2.

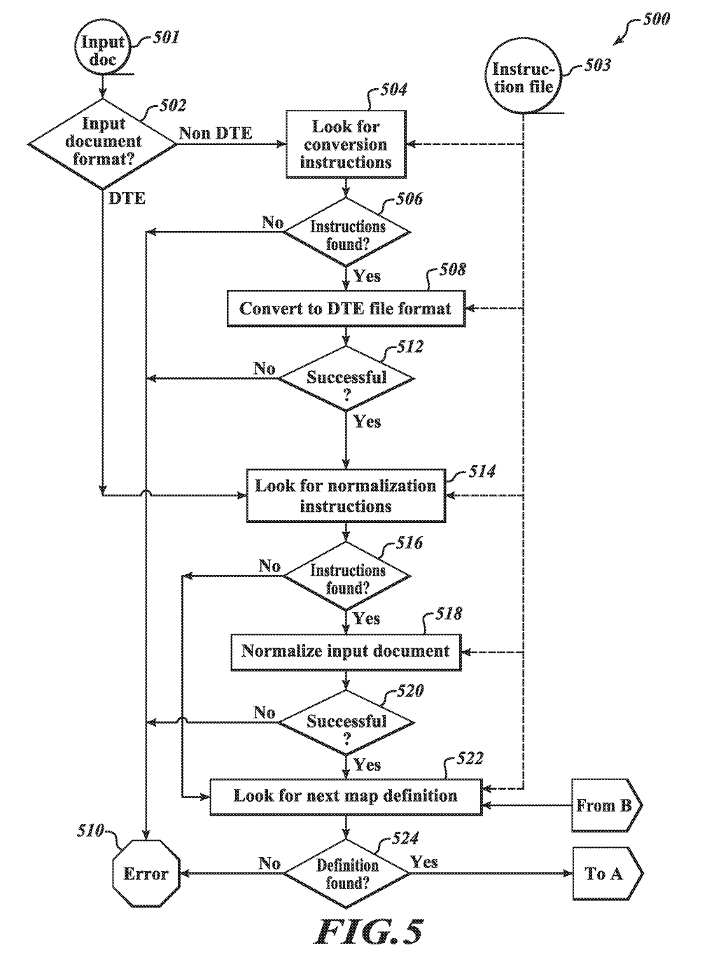

FIGS. 5, 6, 7A and 7B show a low level method 500 of transforming a document or file including converting a file format, normalizing the converted document, obtaining instructions and extracting data or information from header and footer sections in accordance with the instructions, concatenating remaining data or information, extracting data or information from body or line item sections, performing quality assurance and inserting or modifying the information in accordance with the instructions, according to one illustrated embodiment, which may be implemented as part of the method 400 illustrated in FIG. 4.

With reference to FIG. 5, the method 500 may start in response to a call from a program or routine which implements the method 400, or may run currently therewith, for example as a separate process or thread. It is recognized that many of the processes discussed herein may operate in parallel with one or more other processes, on any given document or on a multiple of different documents.

At 502, the document transformation system, for instance a document transformation server computer system, determines or checks a file format of the received or input document 501. In particular, the document transformation system, for instance a document transformation server computer system, may operate using a standard file format, for instance the DTE™ format specified by ecmarket of Vancouver, B.C., Canada. The system may employ other file formats.

If the file format is of the received document is the standard or default file format, then control passes to 514. Otherwise, the document transformation server computer system identifies and/or may optionally attempt to retrieve file format conversion instructions at 504 for the received document, which may include instructions for converting the received document to the standard or default file format. For example, the instruction file may be identified or retrieved based on an identity of a sender, an intended recipient or the identity of a sender/intended recipient pair. Optionally, the transformation instruction file 503 may be based additionally or alternatively on the particular file format, the particular document layout and/or page layout of the received document.

At 506, the document transformation server computer system determines if the attempt to find appropriate file format conversion instructions was successful. For example, the document transformation server computer system determines whether file format conversion instructions for converting from the file format of the received document to a standard or default file format exist in the transformation instructions. If the attempt to find appropriate file format conversion instructions at 504 was successful as determined at 506 control passes to 508. If the attempt to find appropriate file format conversion instructions at 504 was not successful as determined at 506, control passes to an error routine at 510. At 510, the error routine handles and/or reports an occurrence of an error. For example, the error routine may cause a displaying or transmitting of a message indicative of the occurrence or receipt of a document having a file format for which a file format conversion to the standard or default file format has not yet been defined. Such may cause an appropriate file format conversion instructions to be created and stored in the transformation instruction file 503.

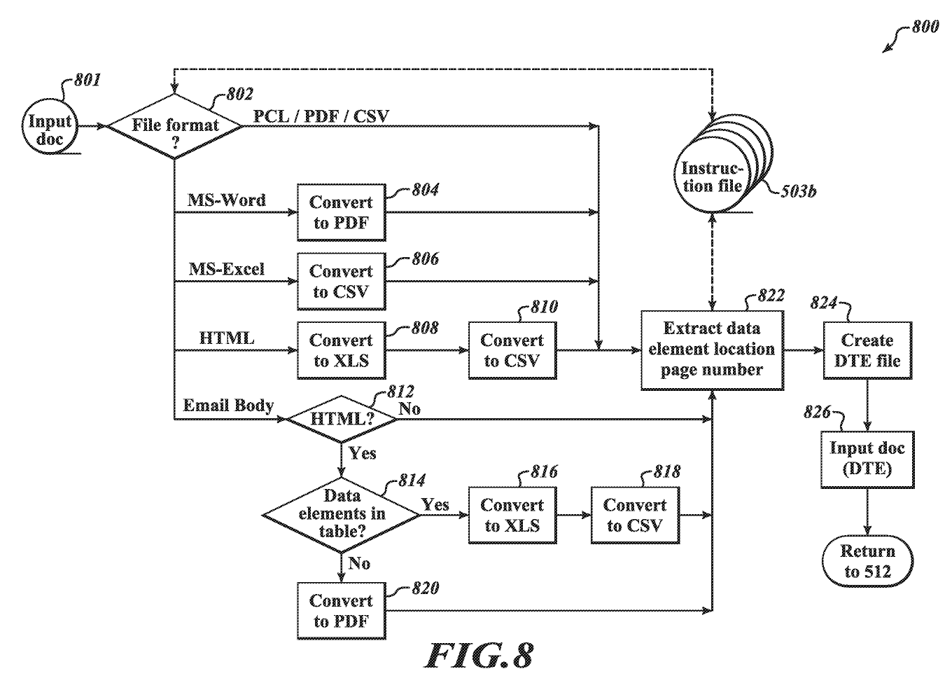

At 508, the document transformation system, for instance a document transformation server computer system, attempts to convert the received document or file 501 to the standard or default file format. The document file format conversion process is discussed in more detail below, with reference to FIG. 8. At 512, the document transformation server computer system determines whether the attempt at the file format conversion was successful. For example, the document transformation server computer system may determine whether the converted document is readable in the standard or default file format. If the attempt to convert the received document or file 501 to the standard or default file format at 508 was successful as determined at 512, control passes to 514. If the attempt to convert the received document or file 501 to the standard or default file format at 508 was not successful as determined at 512, control passes to 510 where the error routine handles and/or reports an occurrence of an error. For example, the error routine may cause a displaying or transmitting of a message indicative of the failure to convert the input document 501 from the one file format to the standard or default file format.

At 514, the document transformation system, for instance a document transformation server computer system, may identify and/or attempt to retrieve a set of instructions, for example normalization instructions, from the transformation instruction file 503. For example, the document transformation server computer system may attempt to retrieve a set of normalization instructions from the instruction file 503 which correspond to information about the received document to be transformed, for example an identity of a sender or sending entity and identification of an intended recipient or recipient entity or sender/intended recipient pair. Optionally, this information may include an identity of the document type of received document (e.g., purchase order, invoice), and/or an identity of document layout of the received document. At 516, the document transformation system, for instance a document transformation server computer system, determines if the set of normalization instructions was successfully found or retrieved. If the attempt to find or retrieve a set of normalization instructions at 514 was successful as determined at 516, control passes to 518. If the attempt to find or retrieve a set of normalization instructions at 514 was not successful as determined at 516, control passes to 522.

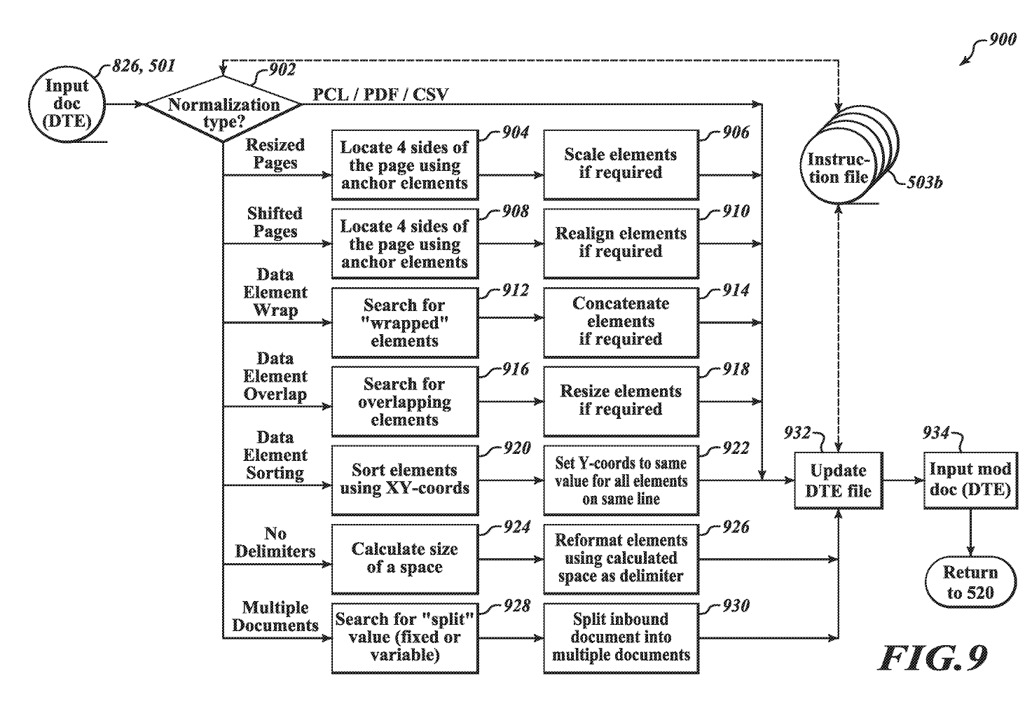

At 518, the document transformation system, for instance the document transformation server computer system attempts to normalize the received document. The process of normalizing is discussed in detail below, with reference to FIG. 9.

At 520, the document transformation system, for instance a document transformation server computer system, determines if the attempt at normalization was successful. If the attempt at normalization at 518 was successful as determined at 520, control passes to 522. If the attempt at normalization at 518 was unsuccessful as determined at 520, control passes to 510 where the error routine handles and/or reports an occurrence of an error. For example, the error routine may cause a displaying or transmitting of a message indicative of the failure to normalize the document with a particular set of instructions.

At 522, the document transformation system, for instance a document transformation server computer system, identifies or attempts to retrieve a map definition or instructions from the transformation instruction file 503 for the received document.

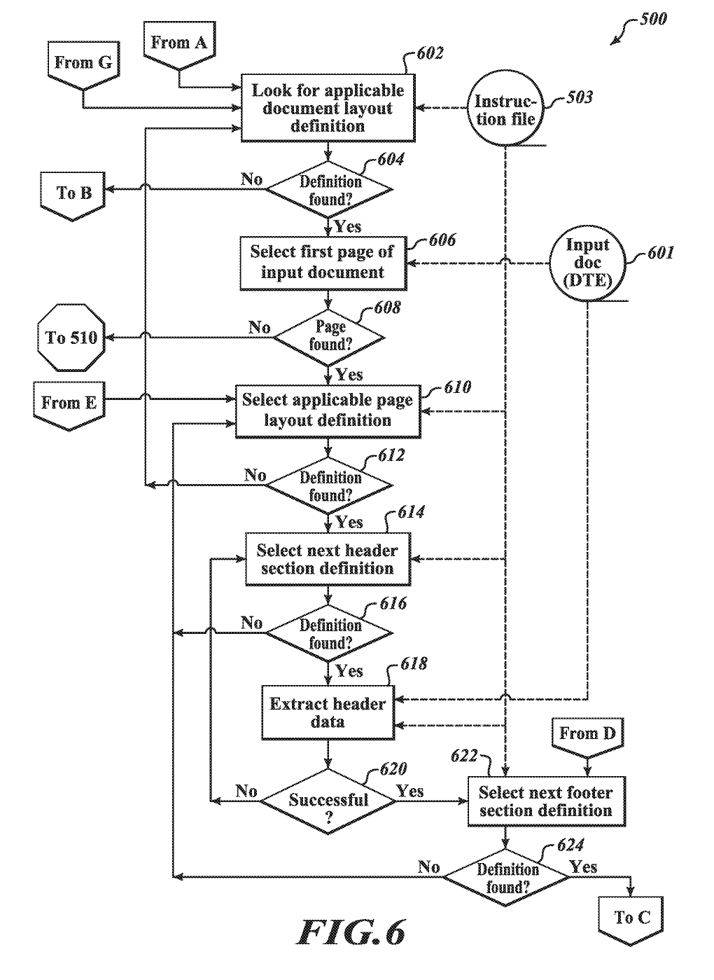

At 524, the document transformation system, for instance a document transformation server computer system, determines if the attempt to identify and/or retrieve the map definition or instructions, for example from the transformation instruction file 503, was successful. If the attempt to identify and/or retrieve the map definition or instructions at 522 successful as determined at 524, the transformation continues along block A, for example as described below with reference to FIG. 6. If the attempt to identify and/or retrieve a map definition or instructions at 522 was unsuccessful as determined at 524, control passes to 510 where the error routine handles and/or reports an occurrence of an error. For example, the error routine may cause a displaying or transmitting of a message indicative of the failure to identify and/or retrieve new map definition or instructions.

With reference to FIG. 6, at 602, the document transformation system, for instance a document transformation server computer system, attempts to identify and/or retrieve applicable document layout definition or instructions, for example from the transformation instruction file 503. At 604, the document transformation system, for instance a document transformation server computer system, determines whether the applicable document layout definition or instructions were found or retrieved. The document layout definition or instructions may be specific to a document layout of a particular document, for example based on a number of pages in the document. The document layout definition or instructions may additionally or alternatively be specific to a type of document (e.g., purchase order, invoice, receipt). If the attempt to retrieve applicable document layout definition or instructions at 602 was determined successful at 604, control passes to 606. If the attempt to retrieve applicable document layout definition or instructions at 602 was determined unsuccessful at 604, control may return via block B to 522 (FIG. 5), where the document transformation system again identifies or attempts to retrieve new applicable map definitions or instructions for the received document.

At 606, the document transformation system, for instance a document transformation server computer system, selects, identifies and/or attempts to retrieve a first page of the input document. At 608, the document transformation system, for instance a document transformation server computer system, determines whether the first page was found. If the first page was found at 606 as determined at 608, control passes to 610. If the first page was not found at 606 as determined at 608, control may pass to an error routine at 510 via block labeled “TO 510” for appropriate reporting of the aberration.

At 610, the document transformation system, for instance a document transformation server computer system, selects, identifies and/or retrieves applicable page layout definition or instructions, for example from the instruction file 503. The page layout definition or instructions may be specific to respective pages of a given input document, for example layout or some section of a subsequent page of a document may be different from a layout of a first page of the same document. For instance, the first page may include a particular header and/or footer, while subsequent pages may have a different header and/or footer, or may omit the header and/or footer. The applicability may, for example, be determined by checking an attribute logically associated with the respective page layout definition or instructions. At 612, the document transformation system determines whether the attempt to select, identify and/or retrieve new applicable page layout definition or instructions was successful. If the attempt to select, identify and/or retrieve new applicable page layout definition or instructions at 610 was successful as determined at 612, control passes to 614. If the attempt to select, identify and/or retrieve new applicable page layout definition or instructions at 610 was unsuccessful as determined at 612, control may return to 602, where the document transformation system again identifies or attempts to retrieve a new set of applicable document layout definition or instructions for the received document.

At 614, the document transformation system, for instance a document transformation server computer system, identifies and/or attempts to retrieve new header section specific extraction definition or instructions, for example from the transformation instruction file 503. The header section specific extraction definition or instructions may be an actual mapping specific to a particular header section of a particular page of a particular document type, and provides the instructions that cause a processor to extract data or information from the specific header section of the received document, and supplies semantic meaning to the extracted data or information. For example, a given data element in the specified header section may be semantically associated with an identity of a sender, while another data element may be semantically associated with an identity of an item being ordered. The logical association thus provides meaning to the data or information. At 616, the document transformation system determines whether the attempt to identify and/or retrieve new header section specific extraction definition or instructions was successful. If the attempt to identify and/or retrieve new header section specific extraction definition or instructions at 614 was successful as determined at 616, control passes to 618. If the attempt to identify and/or retrieve new header section specific extraction definition or instructions at 614 was unsuccessful as determined at 616, control may return to 610, where the document transformation system again identifies or attempts to identify and/or retrieve new applicable page layout definition or instructions for the received document.

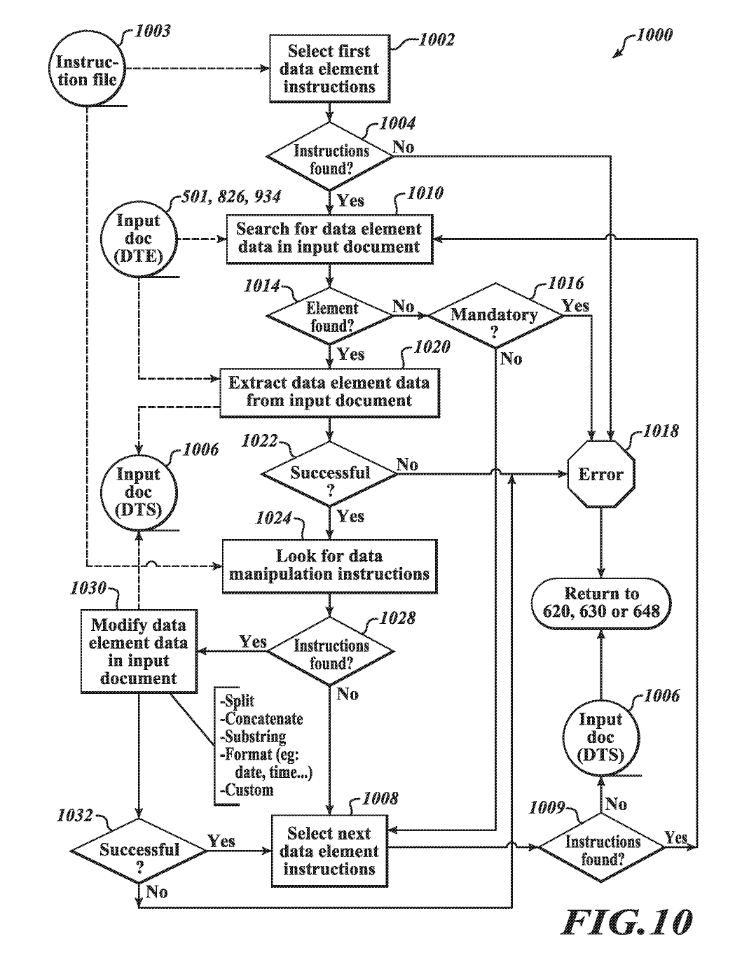

At 618, the document transformation system, for instance a document transformation server computer system, attempts to extract header data or information from a header section of a page of the received document, as stored in a memory structure, according to the header section specific extraction definition instructions. Such is discussed in more detail below with reference to FIG. 10. At 620, the document transformation system determines whether the attempt to extract data or information from the header section was successful. If the attempt to extract data or information from the header section at 618 was successful as determined at 620, control passes to 622. If the attempt to extract data or information from the header section at 618 was unsuccessful as determined at 620, control may return to 614, where the document transformation system again identifies or attempts to retrieve new header section specific extraction definition or instructions.

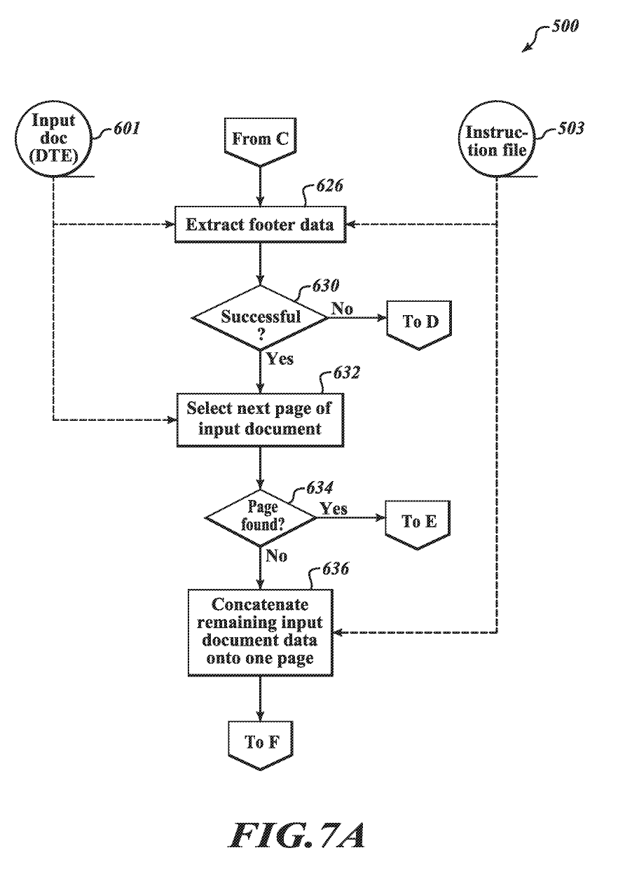

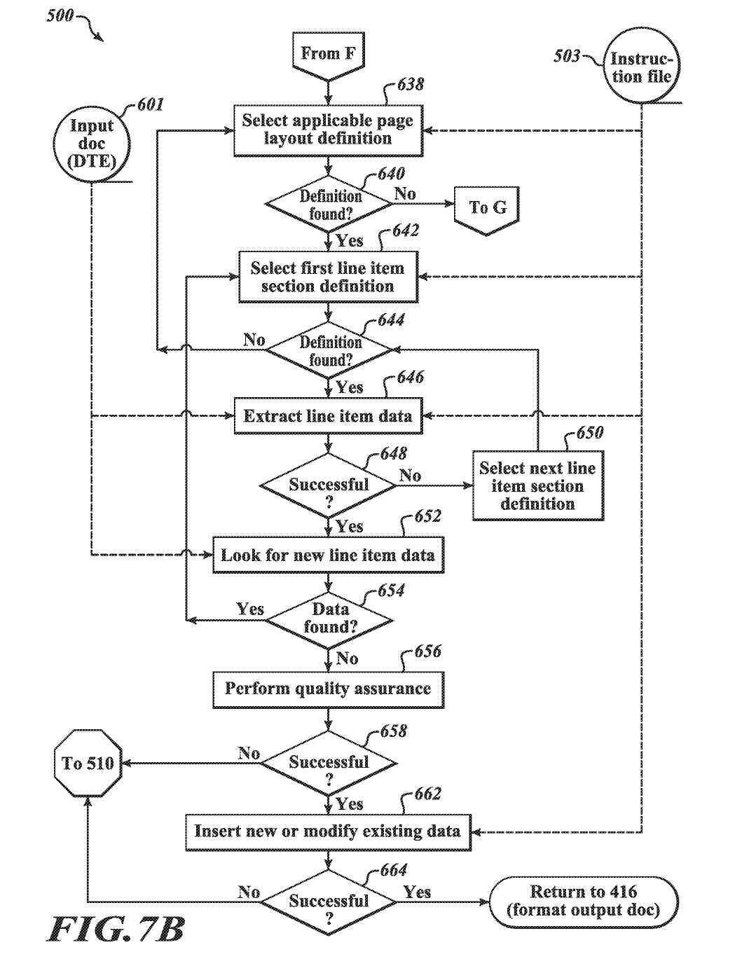

At 622, the document transformation system, for instance a document transformation server computer system, identifies and/or attempts to retrieve new footer section specific extraction definition or instructions, for example from the instruction file 503. The footer section specific extraction definition or instructions may be an actual mapping specific to a particular footer of a particular page of a particular document type, and provides the instructions that cause a processor to extract information from the specific footer section of the received document, as well as provide semantic meaning to the extracted data or information. At 624, the document transformation system determines whether the attempt to identify and/or retrieve new footer section specific extraction definition or instructions was successful. If the attempt to identify and/or retrieve new footer section specific extraction definition or instructions at 622 was successful as determined at 624, control passes to 626 (FIG. 7A) via block C. If the attempt to identify and/or retrieve new footer section specific extraction definition or instructions at 622 was unsuccessful as determined at 624, control may return to 610, where the document transformation system again identifies and/or attempts to retrieve new applicable page layout definition or instructions for the received document.

With reference to FIG. 7A, at 626 the document transformation system, for instance a document transformation server computer system, attempts to extract footer data or information from a footer section of the page of the received document, as stored in the memory structure, according to the footer section specific extraction definition or instructions. Such is discussed in more detail below, with reference to FIG. 10. At 630, the document transformation system determines whether the attempt to extract data or information from the footer section was successful. If the attempt to extract data or information from the footer section at 626 was successful as determined at 630, control may pass to 632. If the attempt to extract data or information from the footer section at 626 was unsuccessful as determined at 630, control may return to 622 via block D, where the document transformation system again identifies or attempts to retrieve a new footer section specific extraction definition or instructions.

At 632, the document transformation system, for instance a document transformation server computer system, selects a next page of the input document. At 634, the document transformation system determines whether a next page was found. If a next page was found at 632 as determined at 634, control passes to 610 via block E where the document transformation server computer system selects an applicable page layout definition or instruction for the new page. If a next page was not found at 632 as determined at 634, control passes to 636.

At 636, the document transformation system, for instance a document transformation server computer system, concatenates data or information remaining on all pages of the received document after extracting data from various sections such as the header and footer sections. For example, the document transformation system may concatenate data or information into a single virtual page in the memory structure or some other memory structure. Control then passes to 638 (FIG. 7B) via block F.

With reference to FIG. 7B, at 638 the document transformation system, for instance a document transformation server computer system, selects, identifies and/or retrieves applicable page layout definition or instructions, for example from the transformation instruction file 503. Notable, all information may be on a single virtual page. At 640, the document transformation system determines whether an applicable page layout definition or instructions were found. If an applicable page layout definition or instructions were found at 638 as determined at 640, control passes to 642. If applicable page layout definition or instructions were not found at 638 as determined at 640, control returns to 602 via block G to find new applicable document layout definition or instructions.

At 642, the document transformation system, for instance a document transformation server computer system, identifies and/or attempts to retrieve new line item specific extraction instructions, for example from the transformation instruction file 503. The line item specific extraction definition or instructions may be an actual mapping specific to the line items from a particular body or line item section of a particular page of a particular document type, and provides the instructions that cause a processor to extract information from the line item section(s) concatenated from the various pages of the input document. At 644, the document transformation system determines whether the attempt to identify and/or retrieve new line item specific extraction definition or instructions was successful. If the attempt to retrieve new line item specific extraction instructions at 642 was successful as determined at 644, control passes to 646. If the attempt to retrieve new line item specific extraction instructions at 642 was unsuccessful as determined at 644, control may pass to 638 to select, identify and/or retrieve new applicable page layout definition or instructions.

At 646, the document transformation system, for instance a document transformation server computer system, attempts to extract body or line item data or information from the concatenated information in the virtual page, as stored in the memory structure or memory vector, according to the line item specific extraction definition or instructions. Such is discussed in more detail below, with reference to FIG. 10. At 648, the document transformation system determines whether the attempt to extract body or line item data or information was successful. If the attempt to extract body or line item data or information from the concatenated information at 646 was successful as determined at 648, control passes to 652. If the attempt to extract body or line item data or information from the concatenated information at 646 was unsuccessful as determined at 648, control may return to 650 to again identify and/or attempt to retrieve new line item specific extraction instructions.

At 652, the document transformation system, for instance a document transformation server computer system, looks for remaining body or line item information in the single virtual page in the memory structure or some other memory structure. At 654, the document transformation system identifies or determines whether there any body or line item information remains. If additional body or line item information remains as determined at 654, control returns to 642 where the document transformation system identifies and/or attempts to retrieve new line item specific extraction instructions. Such may be repeated, for example, until all line items in the body or line item section have been extracted or until all attempts at extraction have failed. If no body or line item information remains as determined at 654, control passes to 656.

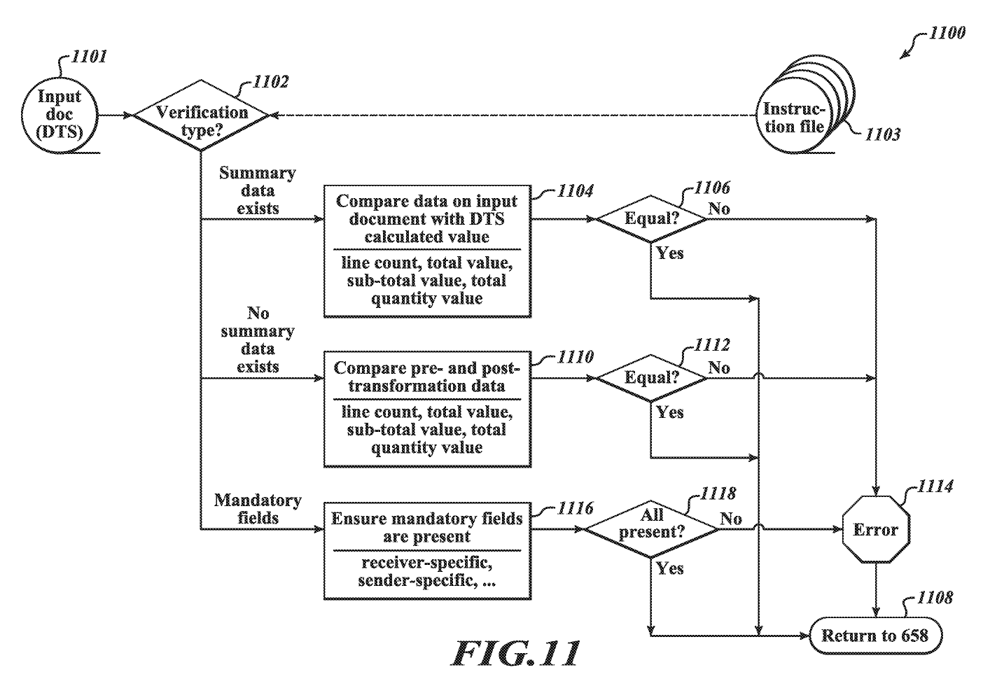

At 656, the document transformation system, for instance a document transformation server computer system, performs quality assurance, confirming that data or information was extracted correctly. Such may, for example, include comparing data or information for example values as such appear in a transformed document to the same data or information as such appear in the document as received (i.e., before transformation). For instance, a sum of cost amounts for each individual line item on a purchase order may be compared to a total cost amount of the purchase order. Such is discussed in more detail below, with reference to FIG. 11.

At 658 the document transformation system, for instance a document transformation server computer system, determines whether the outcome of the quality assurance operation(s) was successful. If the outcome of the quality assurance operation(s) was successful as determined at 658, control may pass to 662. If the outcome of the quality assurance operation(s) was not successful as determined at 658, control may pass to the error routine at 510 via a block “TO 510”, where an error routine handles and/or reports an occurrence of an error. For example, the error routine may cause a displaying or transmitting of a message indicative of a failure to extract line item(s) correctly.

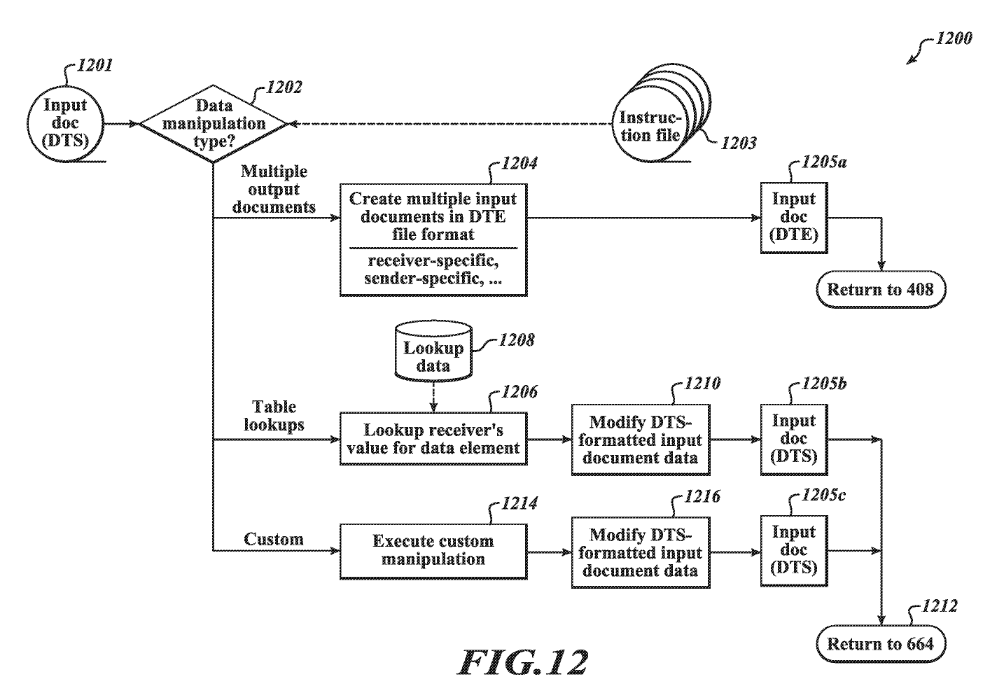

At 662, the document transformation system, for instance a document transformation server computer system, may insert new or modify existing information or data. For example, the information extracted from the input document may be stored in a structured arrangement, for example in a relational database or some other structured format. Such may allow insertion, modification and searching, for example as defined in the transformation instruction file 503. Such is discussed in more detail below, with reference to FIG. 12. At 664, the document transformation system determines whether any attempts to insert new information or modify existing information were successful. If the attempts to insert new information or modify existing information at 662 were successful as determined at 664, the method 500 may terminate or control may return to the 416 (FIG. 4). If the attempts to insert new information or modify existing information at 662 were not successful as determined at 664, control may pass to the error routine at 510 via a block TO 510, where an error routine handles and/or reports an occurrence of an error. For example, the error routine may cause a displaying or transmitting of a message indicative of a failure to insert or modify information correctly.

FIG. 8 is a flow diagram showing a low level method 800 of converting a document, according to one illustrated embodiment, which may be implemented as part of the method 500 illustrated in FIGS. 5, 6, 7A, 7B.

At 802, the document transformation system, for instance a document transformation server computer system, determines a file format of a received document or file 801. For example, the document transformation system may determine whether a received document is a word processor created document (e.g. Microsoft Word®), a spreadsheet (e.g. Microsoft Excel®), HTML document, a body of an email message.

At 804, if the received document is a word processor created document, the document transformation system may convert the document to a PDF file format. Control then passes to 822.

At 806, if the received document is a spreadsheet document, the document transformation system may convert the document to a comma delimited file format (e.g., CSV). Control then passes to 822.

At 808, if the received document is a HTML document, the document transformation system may first convert the document to a spreadsheet file format, then at 810 may convert the resulting spreadsheet file format document to a comma delimited file format (e.g., CSV). Control then passes to 822.

At 812, if the received document is a body of an email message, the document transformation system determines whether the body of the email message is an HTML file format document. If the receive body of the email message is an HTML file format document, at 814 the document transformation system determines whether the document includes data elements in tables. Otherwise, control passes to 822.

If the document includes data elements organized in tables, the document transformation system may first convert the document to a spreadsheet file format document at 816, then at 818 may convert the resulting spreadsheet file format document to a comma delimited file format (e.g., CSV). Control then passes to 822. If the document does not include data elements organized in tables, at 820 the document transformation system may convert the document into a PDF file format document. Control then passes to 822.

At 822, the document transformation system extracts data element data, page number and location coordinates for the one or more data elements of the received document.

At 824, the document transformation system creates or generates a document or file 826 of a standard or default file format, using the data or information from the received document and the relative location of the data elements of the received document. The resulting document or file 826 may be used as an input document or file for the normalization and extraction processes. Hence, control may return to 512 of the method 500 (FIG. 5).

FIG. 9 is a flow diagram showing a low level method 900 of normalizing a document, according to one illustrated embodiment, which may be implemented as part of the method 500 (FIGS. 5, 6, 7A, 7B).

A document or file may have one or more inconsistencies from an expected document format or appearance. For example, the document or file may appear to be slightly smaller or slightly larger than expected, for instance due to automatic scaling preformed by the print drive or device that generates the document. Also for example, the document or file may be shift, for example horizontally or vertically on a page or sheet upon which the document appears or is printed. Also for example, portions of the document may unintentionally be wrapped (e.g., unintentionally extended onto another line or page). Additionally, one or more portions of the data elements may overlap one another. As a further example, data elements in the document may require sorting. As an even further example, the document may be missing delimiters. As an even further example, a document may intentionally or unintentionally include a compendium of separate documents. Often these inconsistencies would be considered “minor” from the perspective of a human since humans are typically able to adjust for these inconsistencies or may not even notice the inconsistencies at all. However, using conventional automation approaches these inconsistencies often make it impossible to automatically transform a document without human intervention.

At 902, the document transformation system, for instance a document transformation server computer system, may determine a type of normalization that is to be performed on a document or file, for example the resulting document 826 or file 501. For example, the document transformation system may determine whether one or more pages need to be resized. Also for example, the document transformation system may determine whether the document includes one or more pages with information or data or data elements that have been shifted with respect to the page. Also for example, the document transformation system may determine whether one or more pieces of data or information or data elements are wrapped or whether one or more data elements are overlapping. The document transformation system may determine whether one or more pieces of data or information or data elements require sorting, whether delimiters are absent or missing or whether the received document contains multiple separate documents.

If one or more pages need to be resized the document transformation system may first locate four sides of the page at 904, then scale one or more of the data elements at 906, as required. The document transformation system may use one or more anchor points to locate the sides of the page.

If information or data or data elements have been shifted with respect to the page, the document transformation system first may first locate four sides of the page at 908, then realign one or more of the data elements at 910, as required. The document transformation system may use one or more anchor points to locate the sides of the page.

If one or more of the data elements are wrapped, the document transformation system first searches for the wrapped pieces of data or information or data elements at 912, and concatenates the wrapped data elements at 914.

If one or more data elements are overlapping the document transformation system first searches for the overlapping pieces of data or information or data elements at 916, then resizes selected ones of the data elements as required at 918, to alleviate the overlap.

If one or more data elements require sorting, the document transformation system first at 920 sorts the pieces of data or information or data elements based on coordinates (e.g., X, Y), then at 922 for each line sets the Y coordinate for all elements on that line equal to a same value.

If delimiters are absent or missing from the document, the document transformation system first calculates a size of a space at 924, then at 926 reformats data elements using the calculated size space as a delimiter.

If the document or file includes multiple separate documents, the document transformation system first searches for one or more “split” values at 928, then at 930 accordingly splits the received document into multiple documents. The “split” values may take a variety of forms but typically are elements or data that represents a split between two documents, for instance a header or header information that appears only a first page of a document, or a page number such as the number “1”.

At 932, the document transformation server computer system may update the previously converted document or file, for example relying on the normalization instructions, for example from a transformation instruction file 503, resulting in a modified input document or file 934.

The resulting modified document or file 934 may be used as an input document or file for the extraction and transformation processes. Hence, control may return to 520 of the method 500 (FIGS. 5, 6, 7A, 7B).

FIG. 10 is a flow diagram showing a low level method 1000 of extracting information from a section of a document and determining whether the extraction was successful, according to one illustrated embodiment, which may be implemented as part of the method 500 illustrated in FIGS. 5, 6, 7A, 7B.

At 1002, the document transformation system, for instance a document transformation server computer system, identifies and/or attempts to retrieve data element specific extraction instructions. For example, the document transformation system may search for a set of instructions or instruction file 1003 (only one illustrated) from the transformation instructions 1003.

At 1004, the document transformation system, for instance a document transformation server computer system, determines whether the attempt to identify and/or retrieve new data element specific extraction instructions was successful. If the attempt to retrieve new data element specific extraction instructions at 1002 was successful as determined 1004, control passes to 1010. If the attempt to retrieve new data element specific extraction instructions at 1002 was unsuccessful as determined at 1004, control passes to an error routine at 1018, where the error routine handles and/or reports an occurrence of an error. For example, the error routine may cause a displaying or transmitting of a message indicative of the occurrence of a failure to find the mandatory or required data in the document 501, 826, 934. Then at 1018 control may return to method 500 (FIGS. 6, 7A, 7B) depending, for example, on which of the pieces of data or information or data elements were being processed (e.g., header, footer, line items).

At 1010 the document transformation system, for instance a document transformation server computer system, attempts to find specific data element data in the received document as stored in memory, for example a modified document 501, 826, 934.

At 1014, the document transformation system, for instance a document transformation server computer system, determines whether the attempt to find the specific data element data in the received document was successful. If the attempt to find the specific data element data in the received document at 1010 was successful as determined at 1014, control passes to 1020 where the document transformation system attempts to extract the data or information of the data element from the input document 501, 826, 934 as stored in memory. If the attempt to find the specific data element data in the received document at 1010 was not successful as determined at 1014, control passes to 1016 where the document transformation system determines whether the data or information is of a type that is considered mandatory or required in order to either process the document or to have a valid transformation. The transformation instruction file, or portions thereof such as the section specific extraction instructions or page layout definitions, may specify which data or information or data elements are mandatory and which are optional. Such may be specific to a sender, an intended recipient or a sender/intended recipient pair.

If the data or information that could not be found is determined to be mandatory or required at 1016, control may optionally pass to an error routine at 1018, where the error routine handles and/or reports an occurrence of an error.

For example, the error routine may cause a displaying or transmitting of a message indicative of the occurrence of a failure to find the mandatory or required data in the document 501, 826, 934. Then at 1018 control may return to method 500 (FIGS. 6, 7A, 7B) depending, for example, on which of the pieces of data or information or data elements were being processed (e.g., header, footer, line items).

If the data or information that could not be found is determined to not be mandatory or required at 1016, control may pass to 1008 where the document transformation system identifies and/or attempts to retrieve a next set of data element specific extraction instructions.

At 1009, the document transformation system, for instance a document transformation server computer system, determines whether the attempt to identify and/or retrieve new data element specific extraction instructions at 1008 was successful. If the attempt to identify and/or retrieve new data element specific extraction instructions at 1008 was successful as determined at 1009, control returns to 1010. If the attempt to identify and/or retrieve new data element specific extraction instructions at 1008 was unsuccessful as determined at 1009, control may return to method 500 (FIGS. 6, 7A, 7B) depending, for example, on which of the pieces of data or information or data elements were being processed (e.g., header, footer, line items).

At 1022, the document transformation system determines if the data or information of the data element was successfully extracted. If the attempt to extract the data or information at 1020 was unsuccessful as determined at 1022, control may optionally pass to the error routine at 1018, where the error routine handles and/or reports an occurrence of an error. For example, the error routine may cause a displaying or transmitting of a message indicative of the occurrence of a failure to extract the data or information from the memory even though the data or information was found. Then at 1018 control may return to method 500 (FIGS. 6, 7A, 7B), the point of return depending, for example, on which of the pieces of data or information or data elements were being processed (e.g., header, footer, line items).

If the attempt to extract the data or information at 1020 was successful as determined at 1022, control may pass to 1024 where the document transformation system, for instance a document transformation server computer system, attempts to identify and/or retrieve data manipulation instructions, for example from the transformation instruction file 1003. Data manipulations instructions may or may not exist for any particular type of data, for example dependent on the sender or originator of the document, the intended recipient or receiver of the document or both. Data manipulation instructions may specify one or more of a large variety of data manipulations to be performed on the extracted data or information. For instance, data manipulation instructions may compare values to each other or to some threshold such a minimum threshold or a maximum threshold. Also for instance, data manipulation instructions may cause performance of some other mathematical operation, for instance summing of certain values. Also for instance, data manipulations instructions may specify certain formatting of data or information.

At 1028, the document transformation system, for instance a document transformation server computer system, determines whether data manipulation instructions were found. If the attempt to find data manipulation instructions at 1024 was successful as determined at 1028, control passes to 1030. If the attempt to find data manipulation instructions at 1024 was unsuccessful as determined at 1028, control may return to 1008 where the document transformation system attempts to identify and/or retrieve new data element specific extraction instructions.

At 1030, the document transformation system, for instance a document transformation server computer system, attempts to modify or manipulate the extracted data or information per the retrieved data manipulation instructions. For example, the document transformation system may initially store the extracted data or information into a structured data storage medium such as a relational database or a spreadsheet on a non-transitory processor-readable medium. The document transformation system may then execute data manipulation instructions using various queries or other data manipulation tools of the relational database or spreadsheet. Such may include searching and extraction or search and replace of selected pieces of data or information, for example pieces of data satisfying some specific criteria set out in the data manipulation instructions. Thus, for example, an intended recipient or receiver of a document being delivered may choose or select to receive only a portion of the data in the sent document, or may have other data or information inserted. Various other data manipulations may be performed.

At 1032, the document transformation system, for instance a document transformation server computer system, determines whether the attempt to manipulate the extracted data per the retrieved data manipulation instructions was successful.

If the attempt to modify or manipulate extracted data at 1030 was successful as determined at 1032, control may return to 1008 where the document transformation system attempts to identify and/or retrieve new data element specific extraction instructions. If the attempt to modify or manipulate the extracted data at 1030 was not successful as determined at 1032, control may optionally pass to the error routine at 1018, where the error routine handles and/or reports an occurrence of an error. For example, the error routine may cause a displaying or transmitting of a message indicative of the occurrence of a failure to manipulate the extracted data or information. Then at 1018 control may return to method 500 (FIGS. 6, 7A, 7B), the point of return depending, for example, on which of the pieces of data or information or data elements were being processed (e.g., header, footer, line items).

FIG. 11 is a flow diagram showing a low level method of performing quality assurance, according to one illustrated embodiment, which may be implemented as part of the method 500 (FIGS. 5, 6, 7A, 7B).

At 1102, the document transformation system, for instance a document transformation server computer system, determines the type of verification to be performed on the transformed document 1101.

In some instances verification may include verifying whether data or information was successfully extracted. For example, the document transformation system may compare extracted data or information to summary data or information from the received document. The summary data or information may, for example, summarize other data or information in the document. For instance, a document such as a purchase order may include a total cost amount 302o (FIG. 3). Such serves as a summary of the purchase order and should reflect the sum of the extended cost amounts 302n of the various line items. Alternatively, the document transformation system may compare various pieces or items of data or information between mid-transformation values or states and post-transformation values or states.

If a received document includes summary data or information, at 1104 the document transformation system, for instance a document transformation server computer system, compares the summary data or information from the received document with a determined or calculated value based on the extracted information or output document. For example, the document transformation system may sum the individual extended cost amounts 302n of the various line items extracted, and compare the total cost amount 302o (FIG. 3) from the input document to that calculated sum. The summary data or information may, for example, include a line count (i.e., total number of line items in body), a total value (i.e., total value of document, for instance total cost amount of purchase order), sub-total value(s) (i.e., total value of a given line item, for instance the product of the quantity of units times the unit cost amount), total quantity value(s) (i.e., total number of items ordered) and/or total number of pages. Other values may be employed, for instance where the document is something other than a purchase order, for instance an invoice or bill of lading.

At 1106, the document transformation system determines if the summary data or information in the input document is equal to the calculated value. If the summary data or information in the input document is equal to the calculated value as determined at 1106, the verification is successful, and at 1108 control may return to 658 (FIG. 7B). If the summary data or information in the input document is not equal to the calculated value as determined at 1106, the verification is unsuccessful, and control may pass to 1114 where an error handling routine handles and/or reports an occurrence of an error. For example, the error routine may cause a displaying or transmitting of a message indicative of the occurrence of a failure to successfully verify the data or information. Then at 1108 control may return to 658 (FIG. 7B).

If a received document does not include summary data or information, at 1110 the document transformation system, for instance a document transformation server computer system, calculates and compares various pieces or items of data or information between mid-transformation values or states and post-transformation values or states. The data or information may, for example, include a line count (i.e., total number of line items in body), total value (i.e., total value of document, for instance total cost amount of purchase order), sub-total value(s) (i.e., total value of a give line item, for instance the product of the quantity of units times the unit cost amount) and/or total quantity value(s) (i.e., total number of items ordered). Other values may be employed, for instance where the document is something other than a purchase order, for instance an invoice or bill of lading.

At 1112, the document transformation system determines if the post-transformation data or information is equal to or matches the mid-transformation data or information. If the post-transformation data or information is equal to or matches the mid-transformation data or information as determined at 1112, the verification is successful, and at 1108 control may return to 658 (FIG. 7B). If the post-transformation data or information is not equal to or does not match the mid-transformation data or information as determined at 1112, the verification is unsuccessful, and control may pass to 1114 where an error handling routine handles and/or reports an occurrence of an error. For example, the error routine may cause a displaying or transmitting of a message indicative of the occurrence of a failure to successfully verify the data or information. Then at 1108 control may return to 658 (FIG. 7B).

In some instances, certain data or information may be mandatory or required in order to successfully process or transform a document. For example, an entity placing a purchase order may need to be identified. If such a verification is to be performed, at 1116 the document transformation system, for example a document transformation server computer system, may ensure that the mandatory or required data elements in the document and populated with data or information. Such may include, for instance, confirming the presence of receiver-specific data or information and/or sender specific data or information. A verification may be performed on the type of data in the data element, for example confirming such is alphabetic or text, or numeric, or is of the appropriate length or contains the appropriate number of digits and/or decimal places. Data or information such as numeric values may also be verified to ascertain that such fall within an appropriate range of values.

At 1118, the document transformation system determines if mandatory or required data or information is present or otherwise meets the requirement(s). If the mandatory or required data or information is present or otherwise meets the requirement(s) as determined at 1118, the verification is successful, and at 1108 control may return to 658 (FIG. 7B). If the mandatory or required data or information is not present or otherwise does not meet the requirement(s) as determined at 1118, the verification is unsuccessful, and control may pass to 1114 where an error handling routine handles and/or reports an occurrence of an error. For example, the error routine may cause a displaying or transmitting of a message indicative of the occurrence of a failure to successfully identify the mandatory or required data or information. Then at 1108 control may return to 658 (FIG. 7B).

FIG. 12 is a flow diagram showing a low level method 1200 of manipulating data or information, according to one illustrated embodiment, which may be implemented, for example, as part of the method 500 (FIGS. 5, 6, 7A, 7B).

At 1202, the document transformation system, for instance a document transformation server computer system, determines a type of data manipulation to be performed on a transformed document 1201 to produce a modified document 1205a, 1205b, 1205c (collectively 1205). A large variety of data or information manipulations may be specified to confirm or customize the document data sent by a sender or originating entity into a form or format desired by an intended recipient or receiving entity. For example, an intended recipient or receiving entity may desire that a single received document be broken out into multiple separate documents. Also for example, the intended recipient or receiving entity may desire only a portion of all of the data or information, and/or may also desire that certain data or information be represented in some other form (e.g., different units or measurements, different currencies, different number of significant digits, different headings, different sections or order of appearance of sections). A few examples of data or information manipulation are discussed below, although the system may implement a large variety of other data or information manipulations as desired. The specific document manipulations may be specified by one or more sets of instructions or instruction files 1203. The instructions 1203 may be identified, for example based on an identity of the intended recipient or receiver and/or based on an identity of the sender or originating entity.

At 1204, if the type of data manipulation is creation of multiple output documents, the document transformation system creates multiple input documents 1205a (only one illustrated) in the desired or default file format and control may pass to 408 (FIG. 4) where each input document 1205a may be queued individually for transformation.

At 1206, if the document includes certain data or information for which the intended recipient wants different data or information, the document transformation system identifies substitute values for the data or information. For example, the document transformation system may identify one or more values based on an identity of the intended recipient or receiver. Such may be accomplished via one or more data repositories 1208, for instance one or more lookup tables or other data stores stored on a non-transitory computer-readable medium.

At 1210 the document transformation system modifies the data or information of the transformed document accordingly to generate or create the modified transformed document 1205b. For example, various values may be replaced. For instance, costs represented in one currency may be replaced with costs represented in another currency. Also for instance, an item number or other identifier employed by the sender may be automatically replaced by a different item number or other identifier that is selected by the intended recipient. Also for instance, a decimal point or other character may either be stripped or added, as desired. Such may allow a given item to be specified by different identifiers.

At 1214, the document transformation system performs or executes any custom manipulations of the transformed document. A few of the many possible manipulations have been discussed above. Other manipulations are of course possible. At 1216, the document transformation system modifies the data or information according to the custom manipulations to generate or create the modified transformed document 1205c.

Upon completion of all manipulations in 1210 and 1216, control may return to 664 (FIG. 7B).

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other systems, not necessarily the exemplary document exchange document transformation system generally described above.

For instance, the foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

Various methods and/or algorithms have been described. Some or all of those methods and/or algorithms may omit some of the described acts or steps, include additional acts or steps, combine acts or steps, and/or may perform some acts or steps in a different order than described. Some of the returns via the various error routines described herein may cause a looping operation, which prevents the document transformation server computer system from inadvertently terminating and encountering an “error out.” For example, in response to a failure to find instructions or process data at some point, the system may attempt to find other instructions, or skip to a new section of a document or page. Such causes the processes to continue, in many cases iteratively attempting to transform the document.

Embodiments described above generally refer to a set of document transformation instructions. Such may, for example be stored in and retrieved from a library or other source of transformation instruction files. Embodiments described above also generally refer to other sets of instructions and/or definitions which may be part of the set of document transformation instructions. In some embodiments, one or more of these other sets of instructions or definitions may exist independent from the set of document transformation instructions. Such may, for example, be stored in and retrieved from respective libraries or other sources.

In addition, those skilled in the art will appreciate that the mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as portable disks and memory, hard disk drives, CD/DVD ROMs, digital tape, computer memory, and other non-transitory computer-readable storage media.

The various embodiments described above can be combined to provide further embodiments. To the extent that they are not inconsistent with the teachings herein, the teachings of: U.S. provisional patent application Ser. No. 61/538,674 filed Sep. 23, 2012, and U.S. nonprovisional patent application Ser. No. 14/346,674 filed Mar. 21, 2014, are incorporated herein by reference in their entirety.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method of operating a document transformation system, comprising:
receiving a first document for processing by the document transformation system;
determining a first set of instructions stored on at least one nontransistory processor-readable medium of the document transformation system based on at least one aspect of the received first document;
based on the first set of instructions which includes at least one set of header specific extraction instructions, at least one set of footer specific extraction instructions and at least one set of line item specific extraction instructions:
attempting to extract header data from a first document according to a first one of the at least one set of header specific extraction instructions of the first set of instructions by the at least one processor of the document transformation system;
attempting to extract footer data from the first document according to a first one of the at least one set of footer specific extraction instructions of the first set of instructions by the at least one processor of the document transformation system;
concatenating remaining data in the first document after extracting all of the header data and all of the footer data from the first document by the at least one processor of the document transformation system; and
attempting to extract a number of line items from the first document according to a first one of the set of at least one set of line item specific extraction instructions of the first set of instructions by the at least one processor of the document transformation system.

2. The method of claim 1, further comprising:
determining whether the attempt to extract the header data from the first document according to the first one of the at least one set of header specific extraction instructions was successful; and
attempting to extract the header data from the first document according to a second one of the at least one set of header specific extraction instructions if the attempt to extract the header data from the first document according to the first one of the at least one set of header specific extraction instructions was unsuccessful.

3. The method of claim 2, further comprising:
determining if the header data was extracted from the first document successfully by the attempt to extract the header data from the first document according to the first one of the at least one set of header specific extraction instructions; and
concluding that the attempt to extract the header data from the first document according to the first one of the at least one set of header specific extraction instructions was successful if the header data was extracted from the first document without any errors.

4. The method of claim 1, further comprising:
determining whether the attempt to extract the footer data from the first document according to the first one of the at least one set of footer specific extraction instructions was successful; and
attempting to extract the footer data from the first document according to a second one of the at least one set of footer specific extraction instructions if the attempt to extract the footer data from the first document according to the first one of the at least one set of footer specific extraction instructions was unsuccessful.

5. The method of claim 4, further comprising:
determining if the footer data was extracted from the first document successfully by the attempt to extract the footer data from the first document according to the first one of the at least one set of footer specific extraction instructions; and
concluding that the attempt to extract the footer data from the first document according to the first one of the at least one set of footer specific extraction instructions was successful if the footer data was extracted from the first document without any errors.

6. The method of claim 1, further comprising:
determining whether the attempt to extract the line item data from the first document according to the first one of the at least one set of line item specific extraction instructions was successful; and
attempting to extract the line item data from the first document according to a second one of the at least one set of line item specific extraction instructions if the attempt to extract the line item data from the first document according to the first one of the at least one set of line item specific extraction instructions was unsuccessful.

7. The method of claim 6, further comprising:
determining if the line item data was extracted from the first document successfully by the attempt to extract the line item data from the first document according to the first one of the at least one set of line item specific extraction instructions; and
concluding that the attempt to extract the line item data from the first document according to the first one of the at least one set of line item specific extraction instructions was successful if the line item data was extracted from the first document without any errors.

8. The method of claim 1, further comprising:
based on a second set of instructions which includes at least one set of header specific extraction instructions, at least one set of footer specific extraction instructions and at least one set of line item specific extraction instructions:
attempting to extract header data from the first document according to a first one of the at least one set of header specific extraction instructions of the second set of instructions;
attempting to extract footer data from the first document according to a first one of the at least one set of footer specific extraction instructions of the second set of instructions;
concatenating remaining data in the first document after extracting all of the header data and all of the footer data from the first document; and
attempting to extract a number of line items from the first document according to a first one of the set of at least one set of line item specific extraction instructions of the second set of instructions.

9. The method of claim 1 wherein concatenating remaining data in the first document includes concatenating remaining data in the first document into a single virtual page.

10. The method of claim 8 wherein concatenating remaining data in the first document into a single virtual page includes concatenating pieces of information from at least two pages of the first document to the single virtual page based on pairs of coordinates to retain a relative positioning of the pieces of information with respect to one another.

11. The method of claim 1, further comprising:
normalizing the first document before attempting to extract any data from the first document.

12. The method of claim 1, further comprising:
converting the first document into a defined transformation file format different from a received file format of the first document before normalizing the first document.

13. The method of claim 1, further comprising:
authenticating an entity that transmitted the first document; and
based at least in part on the identity of the entity that transmitted the first document, selecting a first set of transformation instructions which include at least the first set of instructions.

14. The method of claim 13 wherein selecting the first set of file transformation instructions is based at least in part on an identity of an entity that is to receive the first document.

15. The method of claim 14, further comprising:
generating a recipient document formatted according to a format specified by the entity that is to receive the first document;
transmitting the recipient document to the entity that is to receive the first document.

16. The method of claim 1, further comprising:
storing one or more pieces of data extracted from the first document to a queryable database stored on at least one non-transitory computer-readable medium.

17. The method of claim 1 wherein the first set of instructions is provided as a first transformation instruction file, the at least one nontransistory processor-readable medium of the document transformation system storing a plurality of stored transformation instruction files which differ from one another in one or more criterion.

18. The method of claim 1 wherein determining a first set of instructions based on at least one aspect of the received first document includes determining the first set of instructions based at least on an identity of at least one of a sender or an intended recipient of the first document.

19. A document transformation system, comprising:
at least one processor coupled to receive a plurality of documents transmitted by at least one send system to at least one recipient system; and
at least one non-transitory computer-readable medium that stores processor executable instructions including a first set of instructions which includes at least one set of header specific extraction instructions, at least one set of footer specific extraction instructions and at least one set of line item specific extraction instructions, which when executed by the at least one processor causes the at least one processor to:
determine a first set of instructions stored on at least one nontransistory processor-readable medium of the document transformation system based on at least one aspect of a first document of the plurality of documents received by the at least one processor;
attempt to extract header data from the first document according to a first one of the at least one set of header specific extraction instructions of the first set of instructions;
attempt to extract footer data from the first document according to a first one of the at least one set of footer specific extraction instructions of the first set of instructions;
concatenate remaining data in the first document after extracting all of the header data and all of the footer data from the first document; and
attempt to extract a number of line items from the first document according to a first one of the set of at least one set of line item specific extraction instructions of the first set of instructions.

20. The document transformation system of claim 19 wherein the instructions further cause the at least one processor to:
determine whether the attempt to extract the header data from the first document according to the first one of the at least one set of header specific extraction instructions was successful; and
attempt to extract the header data from the first document according to a second one of the at least one set of header specific extraction instructions if the attempt to extract the header data from the first document according to the first one of the at least one set of header specific extraction instructions was unsuccessful.

21. The document transformation system of claim 20 wherein the instructions further cause the at least one processor to:
determine if the header data was extracted from the first document successfully by the attempt to extract the header data from the first document according to the first one of the at least one set of header specific extraction instructions; and
conclude that the attempt to extract the header data from the first document according to the first one of the at least one set of header specific extraction instructions was successful if the header data was extracted from the first document without any errors.

22. The document transformation system of claim 19 wherein the instructions further cause the at least one processor to:
determine whether the attempt to extract the footer data from the first document according to the first one of the at least one set of footer specific extraction instructions was successful; and
attempt to extract the footer data from the first document according to a second one of the at least one set of footer specific extraction instructions if the attempt to extract the footer data from the first document according to the first one of the at least one set of footer specific extraction instructions was unsuccessful.

23. The document transformation system of claim 22 wherein the instructions further cause the at least one processor to:
determine if the footer data was extracted from the first document successfully by the attempt to extract the footer data from the first document according to the first one of the at least one set of footer specific extraction instructions; and
conclude that the attempt to extract the footer data from the first document according to the first one of the at least one set of footer specific extraction instructions was successful if the footer data was extracted from the first document without any errors.

24. The document transformation system of claim 19 wherein the instructions further cause the at least one processor to:
determine whether the attempt to extract the line item data from the first document according to the first one of the at least one set of line item specific extraction instructions was successful; and
attempt to extract the line item data from the first document according to a second one of the at least one set of line item specific extraction instructions if the attempt to extract the line item data from the first document according to the first one of the at least one set of line item specific extraction instructions was unsuccessful.

25. The document transformation system of claim 24 wherein the instructions further cause the at least one processor to:
determine if the line item data was extracted from the first document successfully by the attempt to extract the line item data from the first document according to the first one of the at least one set of line item specific extraction instructions; and
conclude determine that the attempt to extract the line item data from the first document according to the first one of the at least one set of line item specific extraction instructions was successful if the line item data was extracted from the first document without any errors.

26. The document transformation system of claim 19 wherein the instructions further include a second set of instructions which includes at least one set of header specific extraction instructions, at least one set of footer specific extraction instructions and at least one set of line item specific extraction instructions, execution of the second set of instructions which causes the at least one processor to:
attempt to extract header data from the first document according to a first one of the at least one set of header specific extraction instructions of the second set of instructions;
attempt to extract footer data from the first document according to a first one of the at least one set of footer specific extraction instructions of the second set of instructions;
concatenate remaining data in the first document after extracting all of the header data and all of the footer data from the first document; and
attempt to extract a number of line items from the first document according to a first one of the set of at least one set of line item specific extraction instructions of the second set of instructions.

27. The document transformation system of claim 19 wherein the instructions cause the at least one processor to concatenate remaining data in the first document into a single virtual page.

28. The document transformation system of claim 27 wherein the instructions cause the at least one processor to concatenate pieces of information from at least two pages of the first document to the single virtual page based on pairs of coordinates to retain a relative positioning of the pieces of information with respect to one another.

29. The document transformation system of claim 19 wherein the instructions further cause the at least one processor to:
normalize the first document before attempting to extract data from the first document.

30. The document transformation system of claim 19 wherein the instructions further cause the at least one processor to:
convert the first document into a defined transformation file format different from a received file format of the first document before normalizing the first document.

31. The document transformation system of claim 19 wherein the instructions further cause the at least one processor to:
authenticate an entity that transmitted the first document; and
based at least in part on the identity of the entity that transmitted the first document, select a first set of transformation instructions which include at least the first set of instructions.

32. The document transformation system of claim 31 wherein the at least one processor selects the first set of file transformation instructions based at least in part on an identity of an entity that is to receive the first document.

33. The document transformation system of claim 32 wherein the instructions further cause the at least one processor to:
generate a recipient document formatted according to a format specified by the entity that is to receive the first document;
transmitting the recipient document to the entity that is to receive the first document.

34. The document transformation system of claim 19 wherein the instructions further cause the at least one processor to:
store one or more pieces of data extracted from the first document to a queryable database stored on at least one non-transitory computer-readable medium.

35. A method of operating a document transformation system, comprising:
successively attempting to extract information from a first section of a first page of a first document according to each of a plurality of sets of first section specific extraction instructions of a first set of instructions until an occurrence of a first of: a) the information from the first section of the first document is successfully extracted or b) extraction of the information from the first section of the first document has been unsuccessfully attempted using each of the plurality of sets of first section specific extraction instructions of the first set of instructions;
in response to successfully extracting the information from the first section of the first page of the first document, successively attempting to extract information from a second section of the first page of the first document according to each of a plurality of sets of second section specific extraction instructions of the first set of instructions until an occurrence of a first of: a) the information from the second section of the first document is successfully extracted or b) extraction of the information from the second section of the first document has been unsuccessfully attempted using each of the plurality of sets of second section specific extraction instructions of the first set of instructions; and
if extraction from the first and second sections has been successful, successively attempting to extract information from a third section of at least the first page of the first document according to each of a plurality of sets of third section specific extraction instructions of the first set of instructions until an occurrence of a first of: a) the information from the third section of the first document is successfully extracted or b) extraction of the information from the third section of the first document has been unsuccessfully attempted using each of the plurality of sets of third section specific extraction instructions of the first set of instructions.

36. The method of claim 35, further comprising:
concatenating any information remaining in the first document to a single virtual page after extracting any of the information from each of the first and the second sections of each page of the first document and before successively attempting to extract information from a third section of at least the first page of the first document according to each of a plurality of sets of third section specific extraction instructions.

37. The method of claim 36 wherein the first set of instructions includes a first page layout definition of a plurality of page layout definitions of a number of document layout definitions of at least one map definition in a set of transformation instructions, wherein each of the page layout definitions includes at least one set of first section specific extraction instructions, at least one set of second section specific extraction instructions and at least one set of third section specific extraction instructions, and further comprising:
for each page layout definition, determining whether the page layout definition is appropriate for the first page of the document before successively attempting to extract information from the first section of the first page of the first document according to the set of first section specific extraction instructions.

38. The method of claim 37, further comprising:
determining whether the first document includes a subsequent page;
for each page layout definition, determining whether the page layout definition is appropriate for the subsequent page of the first document;
successively attempting to extract information from a first section of at least the subsequent page of the first document according to each of a plurality of sets of first section specific extraction instructions of at least one page layout definition until an occurrence of a first of: a) the information from the first section of the subsequent page of the first document is successfully extracted or b) extraction of the information from the first section of the subsequent page of the first document has been unsuccessfully attempted using each of the plurality of sets of first section specific extraction instructions of the at least one set of page layout definition; and
in response to successfully extracting the information from the first section of at least the subsequent page of the first document, successively attempting to extract information from a second section of the at least subsequent page of the first document according to each of the plurality of sets of second section specific extraction instructions of the first set of instructions until an occurrence of a first of: a) the information from the second section of the at least subsequent page of the first document is successfully extracted or b) extraction of the information from the second section of the at least subsequent page of the first document has been unsuccessfully attempted using each of the plurality of sets of second section specific extraction instructions of the at least one page layout definition.

39. The method of claim 37, further comprising:
determining whether the extraction of the information from the first section of the first document according to at least one of the plurality of sets of first section specific extraction instructions occurred without any errors; and
in response to concluding that extraction of the information from the first section of the first document according to at least one of the plurality of sets of first section specific extraction instructions did not occur without any errors, determining whether the first set of instructions includes a next page layout definition applicable to the first page of the first document.

40. The method of claim 39, further comprising
determining whether the extraction of the information from the first section of the first document according to at least one of the plurality of sets of first section specific extraction instructions occurred without any errors includes determining whether a total number of data elements and a respective position of each of the data elements in the document matches a total number of data elements and a respective position of each of the data elements specified in the respective set of first section specific extraction instructions of the first page layout definition.

41. The method of claim 37, further comprising:
determining whether the extraction of the information from the second section of the first document according to at least one of the plurality of sets of second section specific extraction instructions occurred without any errors; and
in response to concluding that extraction of the information from the second section of the first document according to at least one of the plurality of sets of second section specific extraction instructions did not occur without any errors, determining whether the first set of instructions includes a next page layout definition applicable to the first page of the first document.

42. The method of claim 35, further comprising:
determining whether all page layout definitions in a document layout definition of a first map definition of the first set of instructions which is applicable to the first page of the first document have been attempted; and
in response to concluding that all page layout definitions which are applicable to the first page of the first document have been attempted unsuccessfully, determining whether a second document layout definition of the first set of instructions applicable to the first document is available.

43. A document transformation system, comprising:
at least one processor coupled to receive a plurality of documents transmitted by at least one send system to at least one recipient system; and
at least one non-transitory computer-readable medium that stores processor executable instructions which when executed by the at least one processor causes the at least one processor to:
successively attempt to extract information from a first section of a first page of a first document according to each of a plurality of sets of first section specific extraction instructions of the first set of instructions until an occurrence of a first of: a) the information from the first section of the first page of the first document is successfully extracted or b) extraction of the information from the first section of the first page of the first document has been unsuccessfully attempted using each of the plurality of sets of first section specific extraction instructions of the first set of instructions;
in response to successful extraction the information from the first section of the first page of the first document, successively attempt to extract information from a second section of the first page of the first document according to each of a plurality of sets of second section specific extraction instructions of the first set of instructions until an occurrence of a first of: a) the information from the second section of the first page of the first document is successfully extracted or b) extraction of the information from the second section of the first page of the first document has been unsuccessfully attempted using each of the plurality of sets of second section specific extraction instructions of the first set of instructions; and
if extraction from the first and second sections has been successful, successively attempt to extract information from a third section of at least the first page of the first document according to each of a plurality of sets of third section specific extraction instructions of the first set of instructions until an occurrence of a first of: a) the information from the third section of the first document is successfully extracted or b) extraction of the information from the third section of the first document has been unsuccessfully attempted using each of the plurality of sets of third section specific extraction instructions of the first set of mapping instructions.

44. The document transformation system of claim 43 wherein the instructions further cause the at least one processor to:
concatenate any information remaining in the first document to a single first page after extraction of any of the information from each of the first and the second sections of each page of the first document and before the successive attempts to extract information from a third section of at least the first page of the first document according to each of a plurality of sets of third section specific extraction instructions.

45. The document transformation system of claim 44 wherein the instructions include a first page layout definition of a plurality of page layout definitions of a number of document layout definitions of at least one map definition in a set of transformation instructions, wherein each of the page layout definitions includes at least one set of first section specific extraction instructions, at least one set of second section specific extraction instructions and at least one set of third section specific extraction instructions, and further comprising:
for each page layout definition, determine whether the page layout definition is appropriate for the first page of the document before the successive attempts to extract information from the first section of the first page of the first document according to the set of first section specific extraction instructions.

46. The document transformation system of claim 45 wherein the instructions further cause the at least one processor to:
determine whether the first document includes a subsequent page;
for each page layout definition, determine whether the page layout definition is appropriate for the subsequent page of the first document;
successively attempt to extract information from a first section of at least the subsequent page of the first document according to each of a plurality of sets of first section specific extraction instructions of at least one page layout definition until an occurrence of a first of: a) the information from the first section of the subsequent page of the first document is successfully extracted or b) extraction of the information from the first section of the subsequent page of the first document has been unsuccessful attempted using each of the plurality of sets of first section specific extraction instructions of the at least one set of page layout definition; and
in response to successful extraction of the information from the first section of the at least subsequent page of the first document, successively attempt to extract information from a second section of the at least subsequent page of the first document according to each of the plurality of sets of second section specific extraction instructions of the first set of instructions until an occurrence of a first of: a) the information from the second section of the at least subsequent page of the first document is successfully extracted or b) extraction of the information from the second section of the at least subsequent page of the first document has been unsuccessfully attempted using each of the plurality of sets of second section specific extraction instructions of the at least one page layout definition.

47. The document transformation system of claim 45 wherein the instructions further cause the at least one processor to:
determine whether the extraction of the information from the first section of the first document according to at least one of the plurality of sets of first section specific extraction instructions occurred without any errors; and
in response to concluding that extraction of the information from the first section of the first document according to at least one of the plurality of sets of first section specific extraction instructions did not occur without any errors, determine whether the first set of instructions includes a next page layout definition applicable to the first page of the first document.

48. The document transformation system of claim 47 wherein the instructions further cause the at least one processor to:
determine whether a total number of data elements and a respective position of each of the data elements in the document matches a total number of data elements and a respective position of each of the data elements specified in the respective set of first section specific extraction instructions of the first page layout definition in order to determine whether the extraction of the information from the first section of the first document according to at least one of the plurality of sets of first section specific extraction instructions occurred without any errors.

49. The document transformation system of claim 45 wherein the instructions further cause the at least one processor to:
determine whether the extraction of the information from the second section of the first document according to at least one of the plurality of sets of second section specific extraction instructions occurred without any errors; and
in response to concluding that extraction of the information from the second section of the first document according to at least one of the plurality of sets of second section specific extraction instructions did not occur without any errors, determine whether the set of instructions includes a next page layout definition applicable to the first page of the first document.

50. The document transformation system of claim 43 wherein the instructions further cause the at least one processor to:
determine whether all page layout definitions in a document layout definition of a first map definition of the first set of instructions which is applicable to the first page of the first document have been attempted; and
in response to concluding that all page layout definitions which are applicable to the first page of the first document have been attempted unsuccessfully, determine whether a second document layout definition of the first set of instructions applicable to the first document is available.

51. A method of operating a document transformation system, comprising:
based on a set of transformation instructions:
determining whether to scale at least a portion of a document;
determining whether to realign at least a portion of the document;
determining whether to concatenate at least a portion of the document;
determining whether to resize at least a portion of the document; and
performing at least one action on the document based at least in part on an outcome of the determinations.

52. The method of claim 51 wherein determining whether to scale at least a portion of a document includes locating four sides of a page of the document based on a number of anchor elements, and wherein performing at least one action on the document based at least in part on an outcome of the determinations includes scaling at least one element of the document.

53. The method of claim 51 wherein determining whether to realign at least a portion of a document includes locating four sides of a page of the document based on a number of anchor elements, and wherein performing at least one action on the document based at least in part on an outcome of the determinations includes realigning at least one element of the document.

54. The method of claim 51 wherein determining whether to concatenate at least a portion of a document includes searching the document for any wrapped elements, and wherein performing at least one action on the document based at least in part on an outcome of the determinations includes concatenating at least two elements of the document.

55. The method of claim 51 wherein determining whether to resize at least a portion of a document includes searching the document for any overlapping elements, and wherein performing at least one action on the document based at least in part on an outcome of the determinations includes resizing at least one of the elements of the document.

56. The method of claim 51, further comprising:
sorting elements in the document based at least in part on coordinate pairs; and
for each line, setting a Y coordinate for all elements on the line to a same value.

57. The method of claim 51, further comprising:
calculating a size of a space that serves as a delimiter between two elements; and
reformatting at least one element based on the calculated space.

58. The method of claim 51, further comprising:
searching at least one section of the document for a split value; and
splitting the document into at least two separate documents in response to finding at least one split value.

59. A document transformation system, comprising:
at least one processor coupled to receive a plurality of documents transmitted by at least one send system to at least one recipient system; and
at least one non-transitory computer-readable medium that stores processor executable instructions including a set of transformation instructions which when executed by the at least one processor causes the at least one processor to:
determine whether to scale at least a portion of a document;
determine whether to realign at least a portion of the document;
determine whether to concatenate at least a portion of the document;
determine whether to resize at least a portion of the document; and
perform at least one action on the document based at least in part on an outcome of the determinations.

60. The document transformation system of claim 59 wherein the instructions cause the at least one processor to locate four sides of a page of the document based on a number of anchor elements to determine whether to scale at least a portion of the document, and scale at least one element of the document to perform the at least one action on the document based at least in part on the outcome of the determinations.

61. The document transformation system of claim 59 wherein the instructions cause the at least one processor to locate four sides of a page of the document based on a number of anchor elements to determine whether to realign at least a portion of the document, and realign at least one element of the document to perform the at least one action on the document based at least in part on the outcome of the determinations.

62. The document transformation system of claim 59 wherein the instructions cause the at least one processor to search the document for any wrapped elements to determine whether to concatenate at least a portion of the document, and to concatenate at least two elements of the document to perform the at least one action on the document based at least in part on the outcome of the determinations.

63. The document transformation system of claim 59 wherein the instructions cause the at least one processor to search the document for any overlapping elements to determine whether to resize at least a portion of the document, and to resize at least one of the elements of the document to perform the at least one action on the document based at least in part on the outcome of the determinations.

64. The document transformation system of claim 59 wherein the instructions further cause the at least one processor to:
sort elements in the document based at least in part on coordinate pairs; and
for each line, set a Y coordinate for all elements on the line to a same value.

65. The document transformation system of claim 59 wherein the instructions further cause the at least one processor to:
calculate a size of a space that serves as a delimiter between two elements; and
reformat at least one element based on the calculated space.

66. The document transformation system of claim 59 wherein the instructions further cause the at least one processor to:
search at least one section of the document for a split value; and
split the document into at least two separate documents in response to finding at least one split value.

67. A method of operating a document transformation system, the method comprising:
comparing by the at least one processor at least one piece of information from a transformed document to at least one piece of information from a pre-transformation document from which the transformed document was generated;
determining by the at least one processor whether the at least one piece of information from the transformed document corresponds to the at least one piece of information from the pre-transformation document from which the transformed document was generated; and
generating by the at least one processor a notification in response to determining that the at least one piece of information from the transformed document does not correspond to the at least one piece of information from the pre-transformation document from which the transformed document was generated.

68. The method of claim 67, further comprising:
calculating at least a first value based on at least one piece of information extracted from the transformed document, and wherein comparing by the at least one processor at least one piece of information from a transformed document to at least one piece of information from a pre-transformation document from which the transformed document was generated includes comparing at least the first value to the at least one piece of information from the pre-transformation document.

69. The method of claim 68 wherein calculating at least the first value based on at least one piece of information extracted from the transformed document includes calculating at least one of a line count, a total value, a sub-total value or a total quantity of items from the transformed document and wherein the at least one piece of information from a pre-transformed document is at least one of a line count, total value, sub-total value or total quantity of items.

70. The method of claim 68, further comprising:
calculating at least a second value based on at least one piece of information from a mid-transformation document, and wherein comparing by at least one processor at least one piece of information from a transformed document to at least one piece of information from a pre-transformation document from which the transformed document was generated includes comparing at least the first value to at least the second value.

71. The method of claim 67 wherein determining by the at least one processor whether the at least one piece of information from the transformed document corresponds to the at least one piece of information from the pre-transformation document from which the transformed document was generated includes: determining whether the at least one piece of information from the transformed document matches the at least one piece of information from the pre-transformation document from which the transformed document was generated.

72. The method of claim 67, further comprising:
confirming by the at least one processor that the transformed document has all of a set of mandatory data elements defined for the document transformation.

73. A document transformation system, comprising:
at least one processor coupled to receive a plurality of documents transmitted by at least one send system to at least one recipient system; and
at least one non-transitory computer-readable medium that stores processor executable instructions that cause the at least one processor to:
compare at least one piece of information from a transformed document to at least one piece of information from a pre-transformation document from which the transformed document was generated;
determine whether the at least one piece of information from the transformed document corresponds to the at least one piece of information from the pre-transformation document from which the transformed document was generated;
generate a notification in response to determining that the at least one piece of information from the transformed document does not correspond to the at least one piece of information from the pre-transformation document from which the transformed document was generated.

74. The document transformation system of claim 73 wherein the at least one processor further calculates at least a first value based on at least one piece of information extracted from the transformed document, and compares at least the first value to the at least one piece of information from the pre-transformation document in order to compare the at least one piece of information from a transformed document to at least one piece of information from a pre-transformation document from which the transformed document was generated.

75. The document transformation system of claim 74 wherein the at least one processor further calculates at least one of a line count, a total value, a sub-total value or a total quantity of items from the transformed document.

76. The document transformation system of claim 75 wherein the at least one processor compares at least one of the line count, the total value, the sub-total value or the total quantity of items calculated from the transformed document respectively to at least one of a line count, a total value, a sub-total value or a total quantity of items from the pre-transformation document to compare at least one piece of information from a transformed document to at least one piece of information from a pre-transformation document from which the transformed document was generated.

77. The document transformation system of claim 74 wherein the at least one processor further calculates at least a second value based on at least one piece of information from a mid-transformation document, and compares the first value with the second value in order to compare the at least one piece of information from the transformed document to the at least one piece of information from the pre-transformation document from which the transformed document was generated.

78. The document transformation system of claim 74 wherein the at least one processor determines whether the at least one piece of information from the transformed document matches the at least one piece of information from the pre-transformation document from which the transformed document was generated to determine whether the at least one piece of information from the transformed document corresponds to the at least one piece of information from the pre-transformation document from which the transformed document was generated.

79. The document transformation system of claim 73 wherein the at least one processor further:
confirms that the transformed document has all of a set of mandatory data elements defined for the document transformation.
